(19) United States
(12) Patent Application Publication
(10) Pub. No.: US 2016/0059120 A1
(43) Pub. Date: Mar. 3, 2016

(54) METHOD OF USING MOTION STATES OF A CONTROL DEVICE FOR CONTROL OF A SYSTEM

(71) Applicant: Aquimo, LLC, Mesa, AZ (US)

(72) Inventors: Robert Sunshin Komorous-King, Berkeley, CA (US); Manoj Kumar Rana, Gurgaon (IN); Mark John Jeffery, Mesa, AZ (US)

(73) Assignee: Aquimo, LLC, Mesa, AZ (US)

(21) Appl. No.: 14/472,164

(22) Filed: Aug. 28, 2014

(51) Int. Cl. A63F 13/211

(52) U.S. Cl. CPC A63F 13/211

(57) ABSTRACT

This invention is for control of a system using motion states of a control device. The method enables complex system control typically controlled by complex controllers, but does not require any buttons or actuators, or video capture of body movements or gesture. An embodiment of the invention utilizes the gyroscope and accelerometer motion sensors of a control device such as a smart phone, smart watch, fitness band, or other device with motion sensors connected, via a cable or wirelessly, to a processor for analysis and translation.

### BACKGROUND OF THE INVENTION

1. Field of the Invention

The present invention relates to a method of using motion states of a control device for control of a system.

2. Description of the Related Art

There is considerable prior art relating to the control of video game systems. A common way to control a video game is to use an interactive game controller. An interactive game controller typically includes multiple buttons, directional pads, analog sticks, etc., to control the play of a video game. An example of such an interactive game controller is disclosed in U.S. Pat. No. 6,394,906 to Ogata entitled “Actuating Device for Game Machine”, assigned to SONY Computer Entertainment, Inc.

Another approach is sensor-driven gaming. Nintendo Co., Ltd. has pioneered the use of sensors in gaming, and certain of their systems utilize a multi-button controller having a three-axis accelerometer. The Nintendo Wii system is augmented with an infrared bar. Other sensor-driven systems such as the SONY PlayStation Move and the Microsoft Xbox Connect use an optical camera to detect motion in time and space.

Yet another approach to system control includes gesture-based systems. As an example, U.S. Published Patent Application 2013/0249786 to Wang entitled “Gesture-Based Control System” discloses a method of control where cameras observe and record images of a user's hand. Each observed movement or gesture is interpreted as a command. Gesture-based systems are also employed to facilitate human-computer interfaces. For example, U.S. Patent Application 2012/0280905 to Stanislav et al. entitled “Identifying Gestures Using Multiple Sensors” focuses primarily on using adaptive sensors or mobile sensors for the use of recognizing continuous human gestures not related to gaming or system control. As another example, WIPO Publication No. WO2011053839 to Bonnet entitled “Systems and Methods for Comprehensive Human Movement Analysis” discloses use of dual 3D camera capture for movement analysis, which are incorporated with audio and human movement for neurological studies and understanding.

Since the advent of the Apple iPhone in 2007, which incorporated motion sensors, many games have used these sensors to incorporate user input motion. U.S. Pat. No. 8,171,145 to Allen, et al. entitled “System and Method for Two Way Communication and Controlling Content in a Game” disclose a method to connect to a web-enabled display on the same wireless network, and to control a video game played on the display using a smartphone. Their game control motions are similar to the Wii however, and are relatively simple motions.

Rolocule Games, of India, has introduced a smartphone-based tennis game, where the user plays an interactive tennis match swinging the phone to (1) serve, (2) hit backhand and (3) forehand shots. Rolocule also has a dancing game where the phone is held in the hand and motions are translated to those of a dancing avatar. Their method in both cases is to project the screen of the phone onto a display device via Apple TV or Google Chromecast. The game play in both cases is similar to prior art games for the Nintendo Wii.

U.S. Published Patent Application 2013/0102419 to Jeffery, et al. entitled “Method and System to Analyze Sports Motions Using Motion Sensors of a Mobile Device” describes a technique to analyze a sports motion using the sensors of a control device. Jeffery et al. use the gyroscope to define a calibration point, and the virtual impact point or release point of a sports motion is calculated relative to this point.

Smartphones can also be used to control complex systems, such as an unmanned aerial vehicle (UAV). U.S. Published Patent Application 2013/0173088 to Callou et al., entitled “Method for the Intuitive Piloting of a Drone by Means of a Remote Control,” discloses a method for control of a drone so that the user's control device motions and orientation are oriented with the drone flight direction and orientation. The motions of the control device are however limited, and use continuous motions of the control device.

Overall, the multi-button, multi-actuator interactive game controller is currently the best device to control a complex game, as the controller enables many dimensions of data input. There is a significant learning curve however, and the control commands are far from intuitive. For example, the controller does not simulate an actual sports motion, and complex button and actuator sequences are required to move an avatar through a virtual world and/or play sports games such as basketball or football. Furthermore, the controller is designed to work by connecting wirelessly to a gaming console.

The Wii remote provides a more realistic experience; however, the remote has several button controls and captures only gross motions of the user via the three axes accelerometer. Typical games played using this remote are simplified sports games. With the exception of bat or racquet motions, the user's avatar responds in a pre-programmed way depending upon the gross sports motion of the player.

Current smartphone based sports games are similar to the Wii—avatar positioning is selected from a small number of predetermined movements (typically a maximum of three) based upon the swing motion. Tennis is a primary example—the three possible motions are serve, forehand and backhand. These motions result in the avatar serving the ball or moving left or right on the court to hit the ball in response to the swing motion—however, the player cannot move the avatar towards the net, move backwards, run diagonally, jump in the air or hit a lob shot, as examples.

Furthermore, current commercially available accelerometers in mobile phones are “noisy” and the gyroscope has drift over a few seconds so that the control device requires re-calibration periodically. Prior art mobile games require a user-defined manual calibration point of the motion sensors. This limitation requires significant simplification of the possible motions for a continuous game, or requires repeated manual calibration, which is not an optimal human interaction.

### SUMMARY OF THE INVENTION

This invention is for control of a system using motion states of a control device. The methods and system of the invention enable complex system control typically controlled by complex controllers, but does not require any buttons or actuators, or video capture of body movements or gestures. An embodiment of the invention utilizes the gyroscope and accelerometer motion sensors of a control device such as a smart phone, smart watch, fitness band, or other device with motion sensors connected, via a cable or wirelessly, to a processor for analysis and translation.

A Motion state is defined as one of a plurality of predefined ranges of orientation around an axis in three-dimensional space. In an embodiment, the combination of rotational motions (from the gyroscope) and acceleration (from the accelerometer) are combined into gravity sensor data, such that in an embodiment a plurality of 4³=64 states of which at least 24 are unique for a control device are defined. One or multiple sequential motion states are defined via a state table to map into system control inputs. That is, a series of motion states defines a new and inventive motion control language with which one can control a system, such as a video game, a robot, a car, and airplane, an aerial drone or an orchestra, for example.

An appropriate analogy is binary ‘words’ in a digital computer, where as an example 64 sequential ones and zeroes (transistor logic gates output highs and lows), are mapped to correspond to unique machine language instructions for a microprocessor. However, ‘words’ in the inventive motion state language are not of a fixed length, hence context is used to uniquely define the system action resulting from a motion sequence.

The new and inventive method described herein to control a system, such as a video game includes: (1) a motion state library defining the sequence of motion states and the corresponding system output(s), (2) a state diagram which defines the multiplicity of motion states possible and their topographical connectedness for a particular system (required if there are temporal dependencies), and (3) a state and sequence analyzer such that specific system events, such as game actions, are triggered upon detection of single or multiple motion state events and dependent upon the state diagram for the system.

There are at least four significant advantages of the invention:
The method does not involve a complex controller with buttons and/or actuators or video/infrared motion capture.
The motion language can be more intuitively defined for humans, and is therefore easier to learn than prior art game control systems and hence games are easier to play and/or complex systems are easier to control.
The method overcomes limitations of the noise of the accelerometer and drift of the gyroscope over time to analyze motions.
The sensors do not require manual calibration—the system is effectively automatically calibrated at each motion state.

The method is extensible to control a plurality of games, systems and technologies. These and other aspects, features, and advantages of the present invention will become apparent from the following detailed description of preferred embodiments, which is to be read in connection with the accompanying drawings.

### BRIEF DESCRIPTION OF THE DRAWINGS

FIG. 1 (a) illustrates an example architecture of a control device;

FIG. 1 (b) illustrates an example architecture of an externally connected motion sensor;

FIGS. 2(a)-(f) illustrate example motion states of a control device;

FIG. 3 illustrates motion states corresponding to the illustrated motion states and their respective gravity and attitude sensor ranges;

FIG. 4 illustrates a flow chart of a method for controlling a system using motion states, according to an embodiment;

FIG. 5(a) illustrates an example of the method for a single player basketball game, wherein movement of an avatar is controlled by hand gestures corresponding to sequences of motion states;

FIG. 5(b) illustrates the corresponding motion state table for the example illustrated in FIG. 5(a);

FIG. 6 (a) illustrates motion state diagrams useable with the basketball game FIG. 5;

FIG. 6 (b) illustrates a state library useable with the basketball game of FIG. 5;

FIG. 7 (a) illustrates gravity data corresponding to various pitch states which correspond in the state library to the system action of shooting a virtual basketball;

FIG. 7 (b) illustrates sports motion analysis of a basketball throw;

FIG. 8. illustrates complex state sequence detection and sports motion analysis;

FIGS. 9(a) and (b) illustrate state diagrams for a more complex basketball game corresponding to offense and defensive avatar control, respectively;

FIG. 10 (a) illustrates a single player basketball game where the motion states are captured by the control device which controls an avatar on a web-enabled display device;

FIG. 10 (b) illustrates multi-player basketball game where the users can be seated or standing;

FIG. 11 illustrates a cloud-based multi-player game platform incorporating multiple player control devices and web-enabled displays;

FIGS. 12(a)-(b) illustrate use of the method for the game of American Football including hand motions of the control device and the corresponding state diagram;

FIGS. 13(a)-(b) illustrate use of the invention for the game of tennis including hand motions of the control device and the corresponding state diagram;

FIGS. 14(a)-(b) illustrate use of the invention for the game of baseball including hand motions of the control device and the corresponding state diagram for a fielder catching and throwing the ball;

FIGS. 15(a)-(b) illustrate use of the method for the game of hockey including hand motions of the control device and the corresponding state diagram;

FIGS. 16(a)-(b) illustrate use of the method for the game of volleyball including hand motions of the control device and the corresponding state diagram;

FIGS. 17(a)-(b) illustrate use of the method for the game of soccer including hand motions of the control device and the corresponding state diagram;

FIGS. 18(a)-(b) illustrate use of the method for a fishing game including hand motions of the control device and the corresponding state diagram;

FIGS. 19(a)-(b) illustrate use of the method for a third person shooter game including hand motions of the control device and the corresponding state diagram for an avatar navigating a virtual battlefield, running/jumping, and shooting;

FIG. 20 illustrates an example architecture of a robotic system with a control device;

FIGS. 21(a)-(b) illustrate use of the method for control of a UAV, including hand motions of the control device and the corresponding state diagram, and;

FIGS. 22 (a)-(c) illustrate use of the method for control of a robot conducting an orchestra, including hand motions of the control device and the corresponding state diagram.

### DETAILED DESCRIPTION OF THE INVENTION

For clarity and consistency, the following definitions are provided for use herein:

As used herein, an output action is a system response to a trigger event. For example, a car turning as a result of rotating the steering wheel, or letters appearing on a computer display in response to typing on a keyboard.

As used herein, a control device refers to a portable device having motion sensors, including, but not limited to, an accelerometer and a gyroscope. In certain embodiments, the motion sensors are integral to the control device. However, in other embodiments, the motion sensors can include external motion sensors. In certain embodiments the control device may have integrated memory and a processor, and in other embodiments the processing may be enabled in a console or PC based system or other mobile device, connected via a cable or wirelessly to the control device.

As used herein, a web-enabled display is any display device with the capability to connect to the Internet and display a web page.

As used herein, sensor data includes any data obtained from a sensor.

As used herein, earth gravity vector is the vector perpendicular to the surface of the earth with an acceleration of approximately 9.8 m/sec² towards the center of the earth.

As used herein, gravity data is the three-dimensional vector output from a gravity sensor. The coordinate system used is non-limiting.

As used herein, attitude describes the orientation, or angular position, of an object in 3-dimensions, relative to an initial starting point.

As used herein, attitude data is the integral of angular velocity over time in a plane tangential to the surface of the earth.

As used herein, a motion state refers to one of a plurality of predefined ranges of orientation around an axis in three-dimensional space. The entire set of motion states covers the entire range of orientation around each of the axes of an orthogonal coordinate system. However, a particular system may only consider certain motion states and/or motion state sequences to be applicable.

As used herein, the global coordinate system is an orthogonal coordinate system affixed to the earth.

As used herein, the object coordinate system is an orthogonal coordinate system affixed locally to the control device.

As used herein, gravity states are ranges of orientation wherein rotations cause changes of the gravity sensor data. These ranges of rotation are around axes perpendicular to the earth gravity vector.

As used herein, attitude states are ranges of rotations entirely in a plane tangential to the earth.

As used herein, a motion state table is the set of motion states applicable to a particular system.

As used herein a motion state sequence is a series of consecutive motion states.

As used herein, the motion state library is the set of motion state sequences and the corresponding output actions for a particular system. The sequences may not be unique, so that a state sequence may have a plurality of corresponding system output actions.

As used herein, a motion state diagram defines the sequential connectedness of states in a particular system.

As used herein, motion state logic is the mapping of motion state sequences to system actions via the motion state library with the constraints of the motion state diagram.

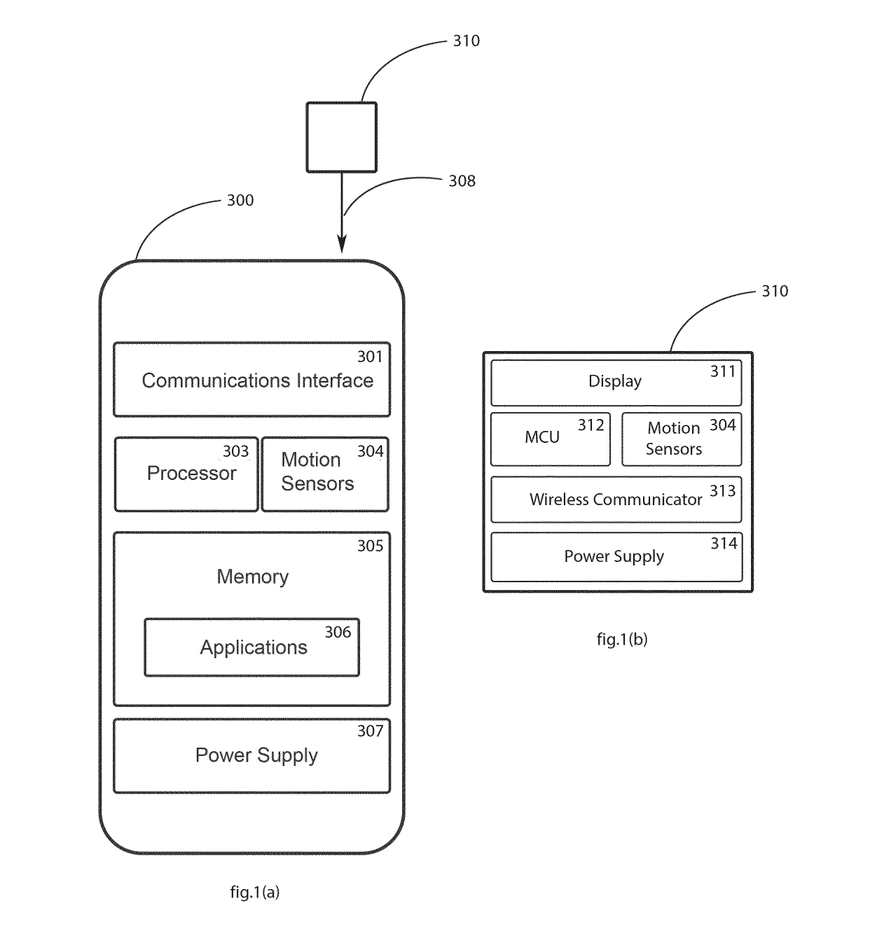

FIG. 1 (a) illustrates an exemplary control device 300, which is an Apple iPhone 5S. The control device 300 includes a communication interface 301, a processor 303, motion sensors 304, a memory 305, and a power supply 307. The communication interface 301 controls various input/output devices including a digital camera, a 30-pin dock connector port, a headphone jack, and a built-in speaker and microphone. The communication interface 301 also controls a touchscreen. The processor 303 is a dual core Apple A5 processor which has a system-on-a-chip (SOC) architecture that integrates the main processor, graphics silicon, and other functions such as a memory controller. The motion sensors 304 can include a three-axis gyroscope to measure a rate of rotation around a particular axis and an accelerometer to measure acceleration in three dimensions of the object coordinate system X, Y and Z. The memory 305 includes 16 GB, 32 GB, or 64 GB of flash memory (depending on the model). The memory 305 includes storage for an application 306 (“app”) which includes the software of the invention. The power supply 307 includes a rechargeable lithium-polymer battery and power charger. A representative gyroscope useable in conjunction with the present invention is the L3G4200D gyroscope made by STMicroelectronics, Inc, and a representative accelerometer is the Bosch Sensortech BMA220 3-axis accelerometer. However, it is to be understood that the present invention is not limited to motion sensor technology currently available. As shown, additional sensors 310 may be connected 308 (wirelessly or via a cable) to the control device 300.

Although the architecture of an Apple iPhone 5S is shown in FIG. 1 for illustrative purposes, it is to be understood that another suitable control device 300 may be used. For example, the control device 300 could instead be a Samsung Galaxy S5 or Galaxy Note 4 smart phone. These devices similarly include the communication interface 301, the processor 303, the motion sensors 304, the memory 305, and the power supply 307. The communication interface 301 works substantially the same on the Galaxy S5 and Galaxy Note 4 whereas multiple input/output devices are also enabled including a 16 Megapixel HDR digital camera, a USB hybrid 3.0/2.0 connecting port, headphone jack, heart rate sensor, and a built-in speaker with dual noise cancellation microphones. The communication interface 301 also controls a touch-screen with enhanced features and sensitivity not requiring the screen to physically be touched to operate. The processor 304 is a QUALCOMM Snapdragon quad-core 2.5 GHz (Galaxy Note 4 clocked higher due to screen size) CPU with Adreno 330 GPU on a programmable system-on-a-chip (PSOC) architecture with integration for other functions such as the memory controller. The motion sensors 304 include an Invense MP65M Gyroscope/Accelerometer which include a six-axis (3-axis gyroscope and a 3-axis accelerometer) on the same silicon die together with an onboard Digital Motion Processor (DMP), and measures acceleration in three dimensions X, Y and Z. The memory 305 includes 16 GB and 32 GB of flash models with an internal SD card slot expansion, which can expand memory with an additional 64 GB. The memory 305 includes storage for an application 306 (“app”) which includes the software of the invention. The power supply 307 includes a lithium-polymer battery and power charger that can be removed and/or expanded.

FIG. 1 (b) shows an exemplary external sensor device 310. In this case, the external sensor device 310 is an activity tracker worn on the wrist and used to track a user's physical activity. An example of such an activity tracker useable for the external sensor device 310 is the The Nike+ FuelBand activity tracker made by Nike, Inc. The Nike+ FuelBand includes a wristband made of a thermoplastic elastometer (TPE). The Nike+ FuelBand 310 can be connected to the control device 300 via a wireless communicator 313 which includes a TiWi-uB2 Bluetooth module. The external motion sensors 304 within the wristband include a tri-axial (STMicroelectronics C3H Accelerometer) accelerometer, and the external processor 312 is an ultra-low power CPU (STMicroelectronic Ultra Low Power MCU with eFlash). The power supply 314 includes two lithium-polymer batteries and is charged through a built-in USB port, which also is the clasp to close the bracelet around the wrist. It is to be understood that the external sensor device 310 could be another device providing motion sensor data to the control device 300, such as a smart watch, a Google Glass, etc.

The method described herein is not limited to control devices such as Apple and Android smartphones, and the control device is not required to connect to the Internet. In an illustrative embodiment, the control device can be the Nintendo Wii controller with optionally the Motion-Plus gyroscope add on. The Nintendo Wii controller is connected via a Bluetooth connection to a gaming console and senses acceleration in 3-axis using an ADXL330 accelerometer. The Wii remote also features a PixArt optical sensor, which in combination with a 10 LED Sensor Bar, physically connected to the game console, allows the determination of where the Wii controller is pointing.

As will be described in greater detail, an important aspect of the present invention is the quantization of motion sensor data obtained from a control device 300 into a relatively small number of discrete “motion states” and to use specific sequences of these motions states for control of a system. A motion state refers to one of a plurality of predefined ranges of orientation around an axis in three-dimensional space. The entire set of motion states covers the entire range of orientation around each of the axes of an orthogonal coordinate system. However, a particular system may only consider certain motion states and/or motion state sequences to be applicable. A motion state may be determined from a user's movement by the motion sensors 304 of the control device 300 held in the hand. In other embodiments, the motion states may be determined from the external motion sensors 310.

Preferably, a “motion state library” can be employed to define the set of motion state sequences for a particular system, where each state sequence corresponds to at least one output action. Each particular system output action is derived by the state logic for a particular system, wherein a particular state sequence, predefined in the state library, is mapped to the appropriate output action of the system via state logic rules. That is, the system action for a state sequence is determined by where the state sequence occurs in a state diagram.

For the control device 300 we define an object coordinate system, which is a Cartesian coordinate system (X, Y and Z), such that Y is along the long axis of the device, X is perpendicular in the short axis of the device, and Z is perpendicular to the face. We similarly define a Cartesian global coordinate system (X_{g}, Y_{g}, Z_{g}) such that the Z_{g} axis is perpendicular to the surface of the Earth and X_{g}, Y_{g} are in the plane tangential to the surface of the earth. The transformation from the global to object Cartesian coordinate system or vice versa is straightforward following well-known methods of matrix algebra given the respective angles of rotation of the axes. It is to be understood that various other coordinate systems may be defined in space, and that the choice and placement of the coordinate system described herein is non-limiting. However, in practice it has been found that the coordinate system described herein is an elegant and useful approach for many applications.

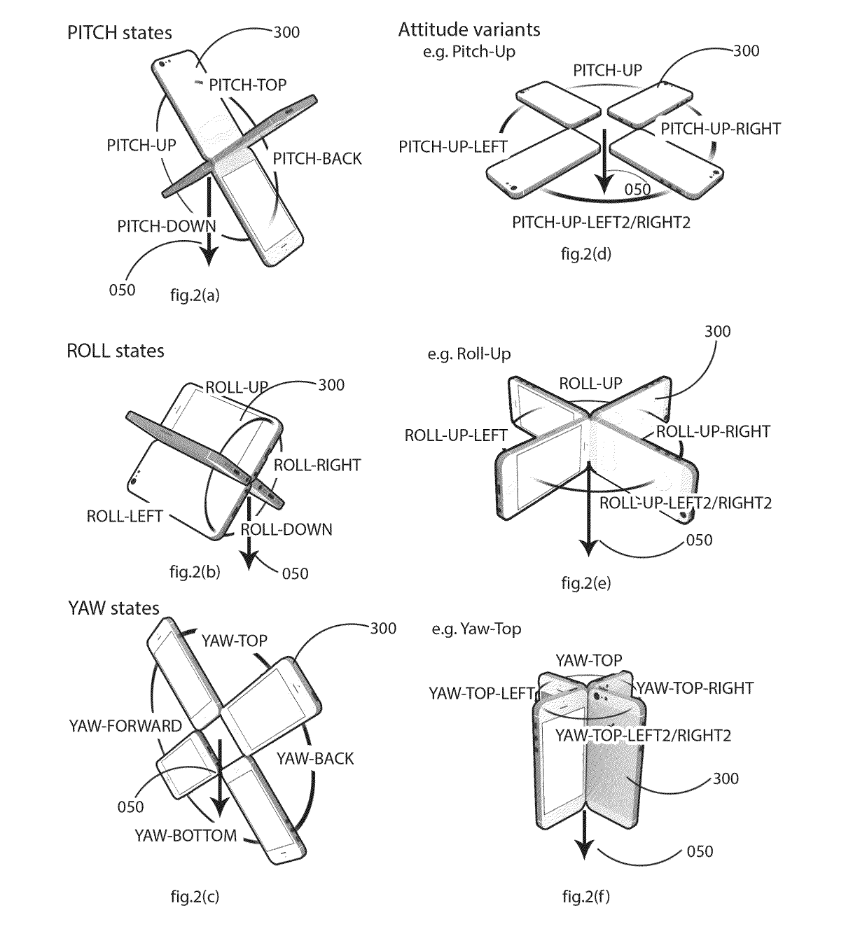

FIGS. 2(a) to (f) illustrate exemplary motion states derived from 90-degree rotations of a gravity sensor, all starting 45 degrees from the axes of the global coordinate system X_{g}, Y_{g}, Z_{g}. FIGS. 2 (a), (b), and (c) show the 90-degree states for rotations in the X, Y, and Z axis (pitch, roll, and yaw respectively), relative to the global coordinate system X_{g}, Y_{g}, Z_{g} and FIGS. 2 (d), (e) and (f) are example 90-degree attitude states. The attitude states are ranges of rotations entirely in a plane tangential to the earth, which is defined by X_{g}, Y_{g} of the global coordinate system.

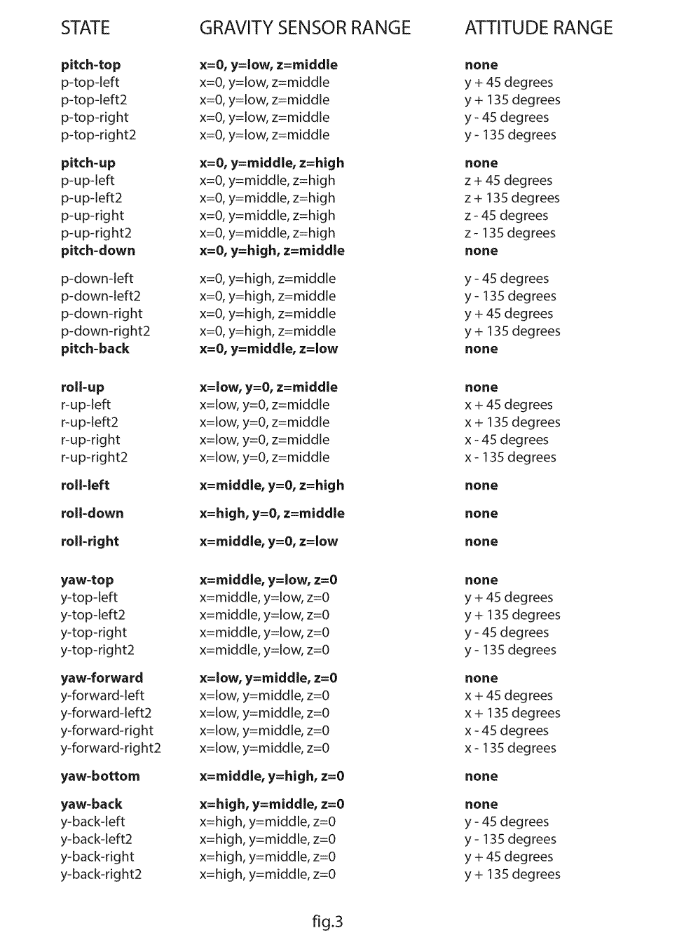

FIG. 3 are possible motion states corresponding to the ranges of motion of the control device 300 in FIGS. 2 (a) to (f), and their combination with attitude states. For clarity throughout we refer to pitch (p), roll (r) and yaw (y) interchangeably, so that p-top is synonymous with the pitch-top state in FIG. 2 (a), for example.

It is to be understood that the coordinate system and the bisected angles may vary in a particular embodiment. That is, the motion states can be defined to be arbitrary rotational angles and it may be advantageous in a particular embodiment to bisect the arc in one dimension more than another, so as to define motion states with higher fidelity in a particular direction. It is to be further understood that the number of states in a particular dimension may vary from the provided examples. The illustrated embodiments are merely exemplary illustrations for a preferred embodiment with 90-degree states: if one were to choose 45-degree rotations the number of states would double, for example. Furthermore, there may be a multitude of control device sensors used to detect these states, and hence the specific sensors used, and the specific outputs of a sensor used to define a particular state, are understood to be non-limiting.

It is to be further understood that multiple sensors may detect different states simultaneously, and that while the invention is illustrated by examples with a single control device 300 the method is extensible to multiple state analysis, with a control device 300 held in one hand and additional sensors 310 on a wrist, for example. These examples are understood to be non-limiting as the method is extensible to an arbitrary number of sensors attached to different parts of the body, such as the ankles, elbows, knees, and head.

Referring to FIG. 3, in an embodiment, gravity data and attitude data are used to define the respective states. Gravity data is typically isolated from raw accelerometer data by removing the “user acceleration” segment (or acceleration imparted on the device by the user) using a low-pass or Kalman filter or sensor fusion algorithms developed by InvenSense and others. Gravity data has the advantage of always pointing towards the center of the earth; hence motion states utilizing gravity data are a priori oriented in space. In an embodiment, we align the motion states relative to the earth gravity vector 050 so that each motion state is defined in space by angular ranges relative to the earth gravity vector 050. In FIGS. 2 (a) to (c), each of the states corresponds to a segment of gravity data in which one axis is near zero: the axis that is near zero is perpendicular to the gravity vector 050.

As the control device 300 is rotated in space, transitions from one state to another can be detected by looking for when the X, Y, Z gravity data (Gravity_{X}, Gravity_{Y}, Gravity_{Z}) has crossed the boundary from one state to another. For the 90-degree states of the exemplary illustration, the transitions between states are demarked by the crossings of projection of the earth gravity vector at 45 degrees. That is, for gravity states the object coordinate system is understood to be rotating in space about axes that are tangential to the earth gravity vector, see FIG. 2 (a)-(c). The gravity state transitions are observed when the object coordinate system axes cross p degree bisectors to the global coordinate system axes, where p is 45 degrees in an embodiment.

Typical gravity data outputs of motions sensors 304 have maximum ranges from +9.8 m/sec² to -9.8 m/sec². The magnitude of the earth gravity vector at 45 degrees projected towards the center of the earth is given by:

g_{Z}=g sin)(45°=9.8 m/s²×0.707=6.929 m/sec²˜7 m/s².

In an embodiment, we define ranges of gravity sensor data so that motion states can be easily detected in one of three ranges of gravity data: High (greater than +7 m/s²), Middle (between −7 and +7 m/s²), and Low (less than −7 m/s²). So the motion states FIG. 2 (a)-(c) of a control device can be determined by (1) measuring the X, Y, and Z output of the gravity sensor, (2) determining the range of each and (3) then comparing these readings to the motion state table FIG. 3.

For example, the Pitch-Top motion state, FIG. 2 (a), is defined as having a Low Gravity_{Y} reading and a Middle Gravity_{Z} reading. Hence, a control device that moves from Low Gravity_{Y} and Middle Gravity_{Z} to Middle Gravity_{Y} and High Gravity_{Z} has just moved from the motion state Pitch-Top to Pitch-Up and, referring to FIG. 2 (a), has just been rotated forward and down.

FIG. 2 (d)-(f) illustrates exemplary attitude variants of each motion state. Because gravity data does not recognize rotations in a plane that is tangent to the earth's surface, X_{g}, Y_{g} for the global coordinate system, in a preferred embodiment we employ attitude data to detect these rotational states. Attitude state changes are detected when attitude data changes more than q-degrees relative to an initial starting point, where q is 45 degrees in an embodiment. In a preferred embodiment we monitor attitude as the gravitational sensors transition to one of Gravity_{X} Gravity_{Y} or Gravity_{Z} close to zero, and use these attitude data as the starting point of an attitude rotation. We then compare beginning attitude data to ending attitude data and look for transitions greater than q degrees to define changes in attitude states, where q is 45 degrees in an embodiment.

In an alternate embodiment, for attitude states we use the magnetic compass sensor to orient the X_{g}, Y_{g} axes of the global coordinate system. In this embodiment, attitude state changes are detected relative to magnetic North for the user wherein an offset angle is used to place the global coordinate system, where the offset angle is the difference between the average attitude of the user and magnetic North. In an embodiment we calibrate the attitude of the control device using an average attitude direction of the first few gravity state motions of the user, preferably three in an embodiment. The calibration provides an offset angle relative to the magnetic North of the user, from which we can orient the global coordinate system. However, the calibration method is understood to be non-limiting, and an application may require the user to hold the control device in their preferred attitude direction for a period of time, preferably holding still for one second, before initiating a motion state sequence, or as an alternate embodiment the calibration may be executed at each gravity state change, as an example. The use of the magnetic compass sensor has the advantage of orienting the user relative to a fixed direction on the Earth, which may be useful for applications including UAVs, for example.

Accelerometer and magnetic compass sensor data is noisy, however, and often contains spikes from high frequency movements. In an embodiment it may be advantageous to apply a low pass filter to accelerometer and magnetic sensor data, or preferably a Kalman filter if there are constraints on the motion states, in order to remove the high frequency component; see, for example, U.S. Pat. No. 8,326,533 to Sachs et al., entitled “Apparatus and Methodology for Calibration of a Gyroscope and a Compass Included in a Handheld Device,” which is incorporated by reference herein in its entirety. Sensor fusion techniques are well known in the art; see, for example, U.S. Pat. No. 8,441,438 to Ye et al., entitled “3D pointing device and method for compensating movement thereof.” In an embodiment, a sensor fusion method combining accelerometer sensor and gyroscope sensor data and/or magnetic sensor and gyroscope sensor data is used to more accurately calculate the gravity data and/or magnetic compass data, respectively.

As an illustrative example for the pitch-up motion state, see FIG. 2 (d), there are four corresponding attitude variants defined as 90-degree rotations around the Z-axis. These states are 90-degree rotation segments and as measured from the first data point recorded after the device enters the motion state. As an example, if a control device 300 enters the Pitch-Up motion state and then makes a 45 degree attitude Z rotation to the left, the control device 300 will now register itself in the pitch-up-left motion state. If the control device 300 continues to rotate another 90 degrees in attitude Z, the device 300 will now register itself in the pitch-up-left2 motion state. It should be noted that the pitch-up-left2 and pitch-up-right2 motion states correspond to the identical orientation of the control device 300; what differentiates them is the direction the control device 300 takes in arriving at these respective motion states. FIG. 3 therefore illustrates an exemplary table of the possible states for 90-degree rotations of a control device 300 and their corresponding ranges of gravity data and attitude data.

Note that the embodiment detects transitions between states and is robust so that the exact gravity or attitude sensor reading is not required to identify a change in state. In an embodiment, it is useful to define a threshold range A, approximately 10% of the threshold values in gravity and attitude data, so that a state change is recorded to have occurred if gravity or attitude data is plus or minus Δ in the range of the state transition. Hence, if the control device is held close to a state change the state does not change unless it has crossed the threshold in gravity or attitude data plus or minus Δ. The Δ used in an embodiment is understood to be non-limiting.

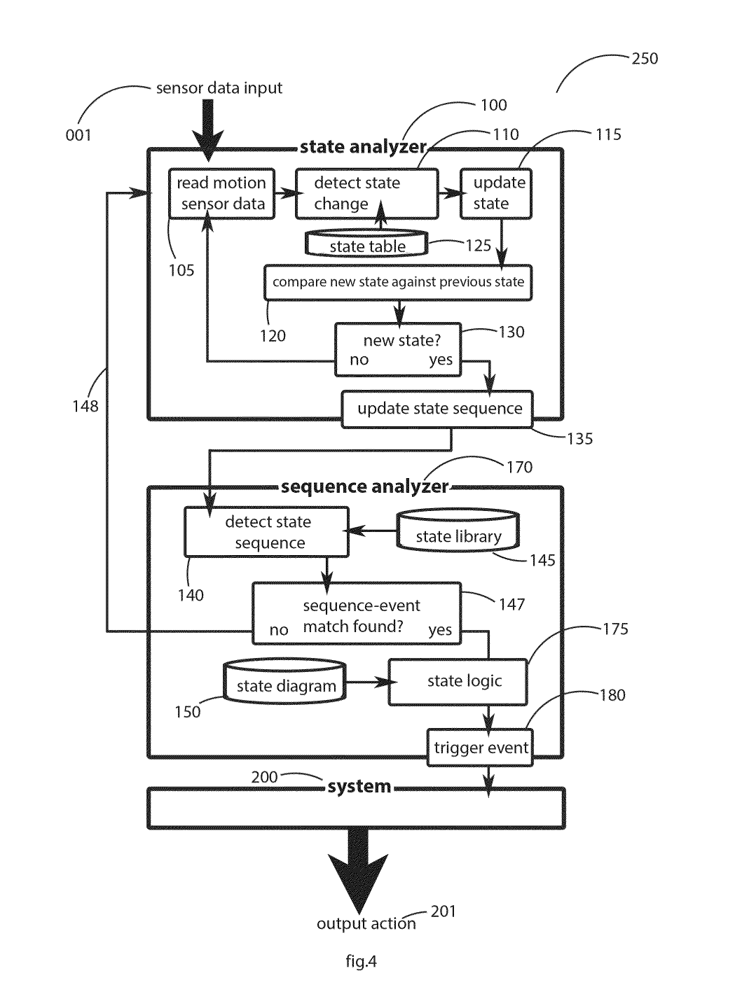

FIG. 4 is an illustrative diagram of a preferred embodiment of an inventive method 250. The method uses two major components: (1) a state analyzer 100 and (2) a sequence analyzer 170. Motion sensor data 001 is continuously monitored in 105. In a preferred embodiment, the motion states are 90-degree sections of gravity data rotations on one axis. When a motion state transition is detected 110 the motion state is compared to a state table 125 containing a set of motion states applicable to the particular system. If it is found in the state table, the motion state is considered a valid state for the system and the current motion state is updated 115. This current motion state may however be the same as the previous motion state. Hence, the motion state sequence 135 is updated only if the motion state has changed. There are many possible motions states, and a finite number will have relevance to control a particular system. If the motion state is not found in the state table 125, the motion state is not changed in the state sequence 135, with the exception of “special moves” described below.

These data from 135 are then passed to the sequence analyzer 170. The sequence analyzer 170 maps the motion state sequence to the appropriate system control output 201. The motion state library 145 contains predefined motion state sequences and the input state sequences 135 are monitored in 140 for matches 147 against the motion state library. If no motion state sequence is found the method returns 148 to the state analyzer 100 to continue monitoring for motion state changes. If a motion state sequence is found, state logic 175 is applied which determines the correct trigger event 180 given the constraints of the motion state diagram 150. The method 250 output is the correct trigger event 180 that is the input to control the system 200, which in turn creates that output action 201. Note that the state logic 175 can be complex and take into consideration various factors beyond just the change of state of the controller.

As an example of complex logic 175 for an embodiment applicable to sports games, the state logic 175 can trigger the analysis of sports motions, which are then input to a gaming graphics engine 200. The sports motion analysis follows the method of Jeffery, et al. U.S. Published Patent Application 2013/0102419, “Method and System to Analyze Sports Motions Using Motion Sensors of a Mobile Device”, wherein the calibration point at the beginning of the sports motion is selected as a transition to the appropriate motion state in the related motion state sequence.

It is to be understood that many variations of the method 250 are realizable, and that the steps may be undertaken in a different order in a particular embodiment, and may be distributed across processing devices, and therefore the method in this example is non-limiting.

Preferably, the method 250 is asynchronous, with events arriving and being detected as they occur, however in an alternate embodiment the method 250 may be synchronous with clocking of the state analyzer engine 100 and the sequence analyzer 170 so that the motion state sequence has a well-defined periodicity and, if no motion state change occurs in a clock period, the motion state is duplicated in the motion state sequence table. In this example the sequence analyzer has logic 140 to manage duplicates and accurately detect state sequences.

The present invention will be further clarified by the following example of a basketball game implemented using techniques described herein, according to an embodiment of the present invention. For illustrative clarity, the example has a limited number of states and assumes an embodiment where the control device 300 is held in the hand 010 of the user. As discussed previously, many possible embodiments are possible with current and future technology and sensor configurations; hence the example is non-limiting.

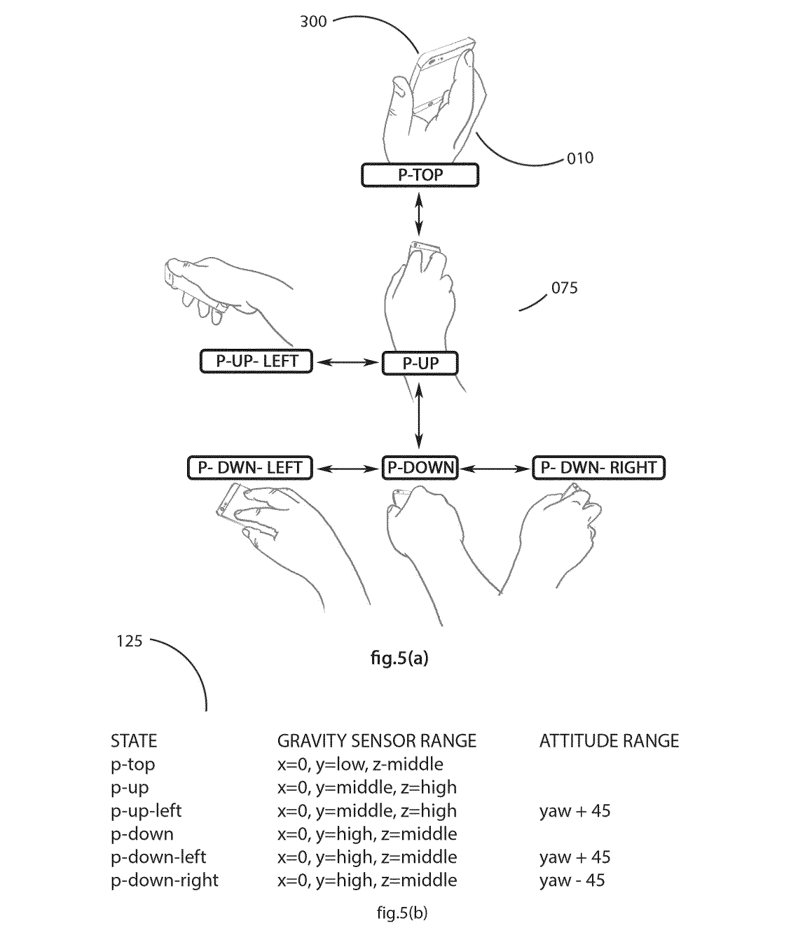

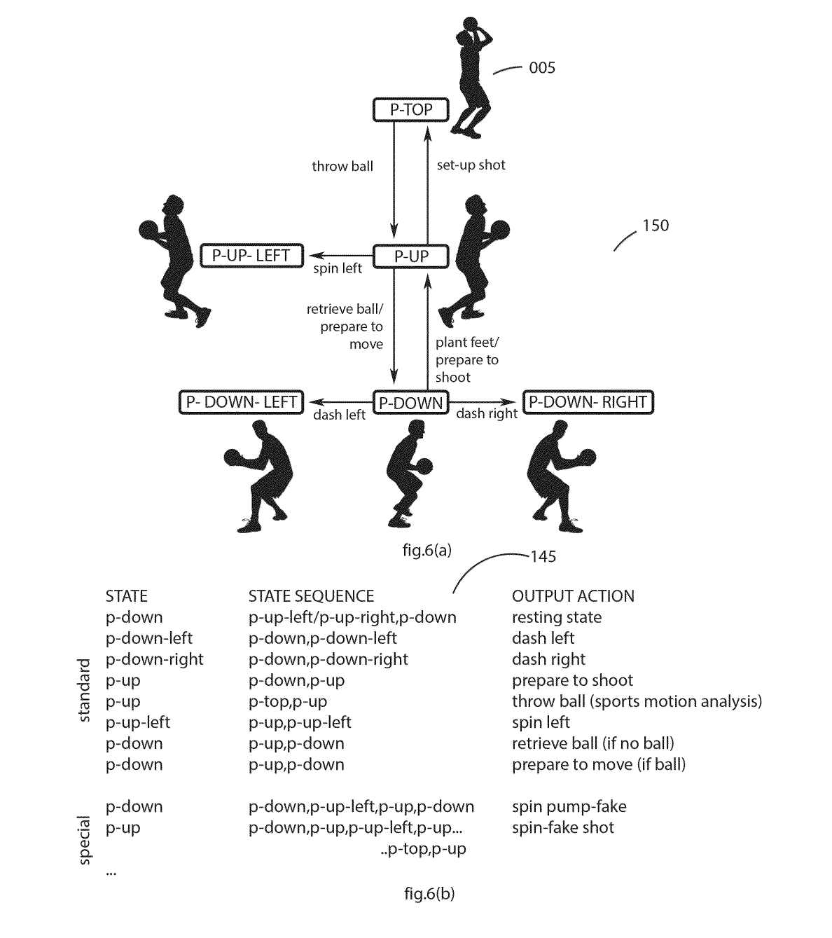

FIG. 5 (a) illustrates hand motions 075 that control particular aspects of a basketball computer game. FIG. 5 (b) is the corresponding state table 125 that defines motion states that are relevant to the basketball game with the respective ranges of sensor data as defined in FIG. 3. FIG. 6 (a) is the corresponding motion state diagram 150 corresponding to the hand motions 075 and FIG. 6 (b) is the exemplary motion state library 145 for the simplified basketball example. Arrows in the motion state diagram 150 denote a directional movement from one motion state to another.

As an illustrative example, in FIG. 6 (b) a movement from p-top to p-up will result in the player's avatar throwing the basketball at the hoop and a movement from p-down to p-down-right will result in the player's avatar dashing to the right and moving to a new position on the basketball court. Hence, the state diagram 150 in FIG. 6 (b) uniquely defines the output actions for different motion state sequences.

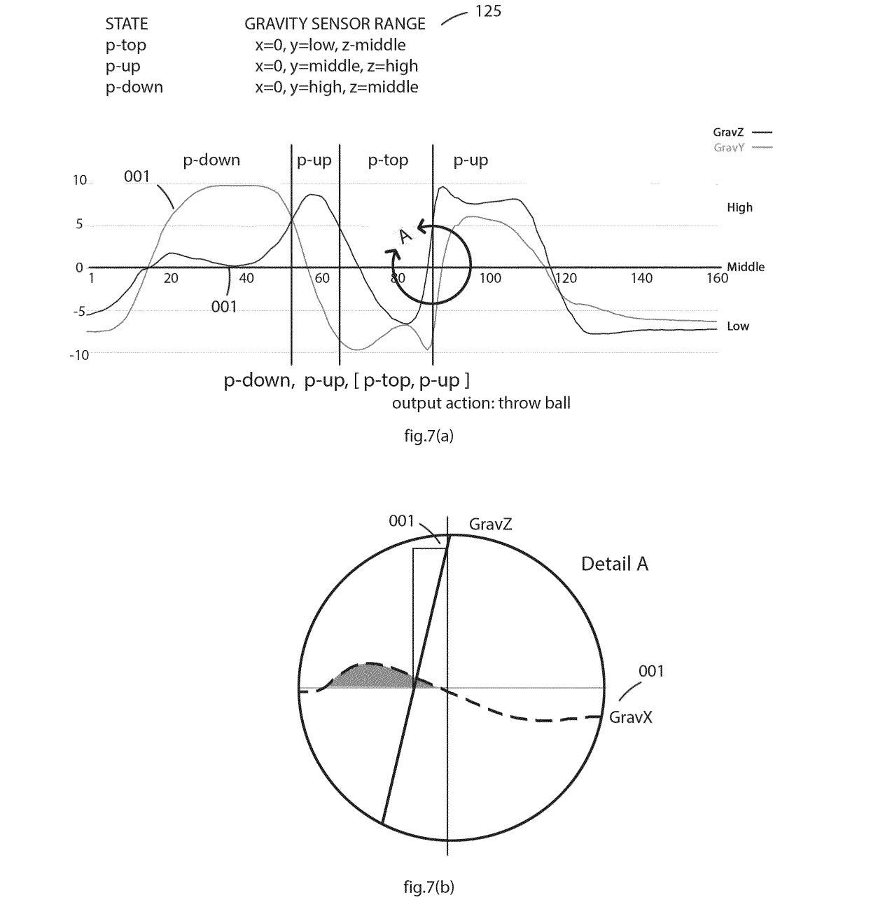

The actual sports motion analysis for the basketball throw is computed separately from the motion state sequence analysis. FIG. 7 (a) illustrates gravity data corresponding to a representative basketball throw. The motion states found in this data match motion states in the motion state library 145, see FIG. 6 (b), and occur in a sequence of p-down, p-up, p-top, p-up. The last two motion states in this sequence are matched to the output action of “throw ball” in the motion state library FIG. 6 (b). When this motion state sequence is detected in the method 250 the trigger event 180 is to execute two calculations from the Gravity_{Z} and Gravity_{X} data, see FIG. 7 (b). The first, which is correlated to the speed at which the ball is thrown, is the slope of GravityZ data at the output action. This slope is calculated from the data points preceding the point at which the control device 300 leaves the p-top state and enters the p-up state (the throw ball action). The second, which is correlated to the direction the ball is thrown, is an average of Gravity_{X} taken from the data points preceding that same throw ball action. These calculations output the direction and velocity passed to the graphics engine.

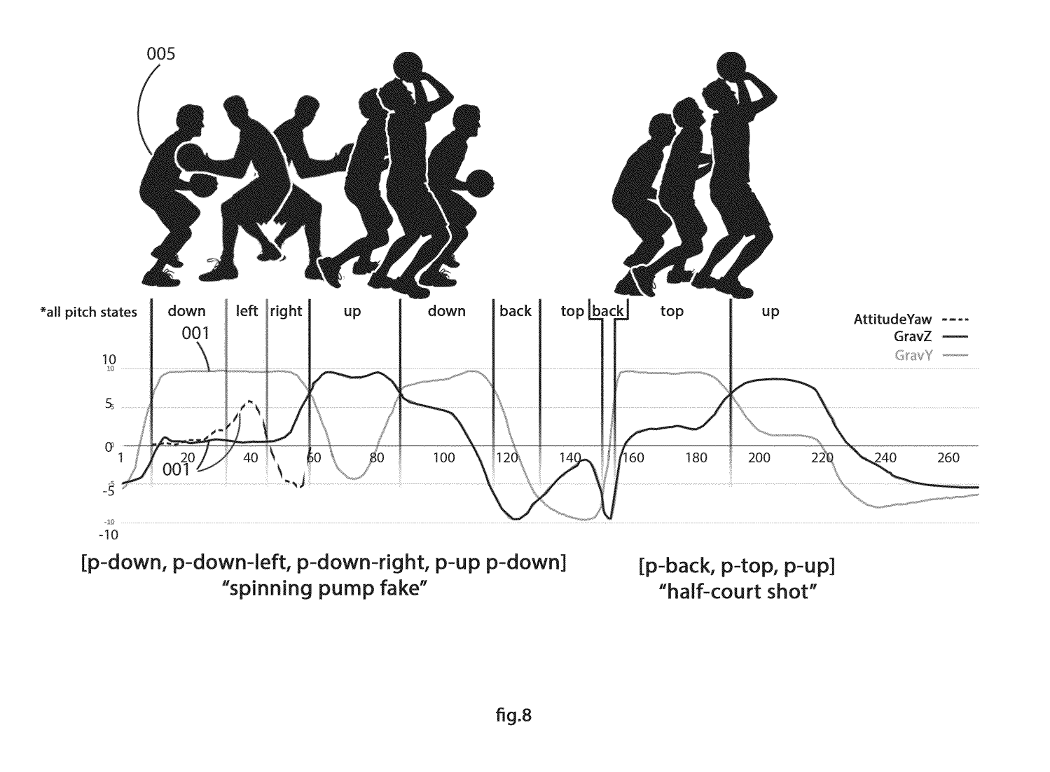

In an embodiment, we define a “special move” as a motion state sequence that occurs in a predefined time interval. As an illustrative example: four states in succession executed in less than 3 seconds. FIG. 6 (b) illustrates three special move state sequences, the spin pump-fake, the spin-fake shot, and the half-court shot. FIG. 8 illustrates gravity data taken from a representative basketball special move. The sequences of motion states in this data match two special moves in the motion state library: the spinning pump fake (p-down, p-up-left, p-up, p-down) and the half-court shot (p-back, p-top, p-up). When these sequences of motion states are executed in rapid succession the output actions of spinning pump fake and half-court shot will be executed by the in-game avatar.

The “special move” is an illustrative example of how the output action 201 is not necessarily just a predetermined ‘stock’ action and the state logic 175 can involve complex analysis. For example the “windmill dunk” special move requires four state changes, and results in a predefined windmill dunk avatar sequence. However, additional variables including directions, speed and velocity of the various state transitions are used to make a slow vs fast windmill dunk, or a complete miss if the state sequence was executed with bad timing, as examples. Hence, additional data including, but not limited to, data from the sensors 304 maybe combined in the state logic 175 to create a complex output action 201 that is not pre-determined.

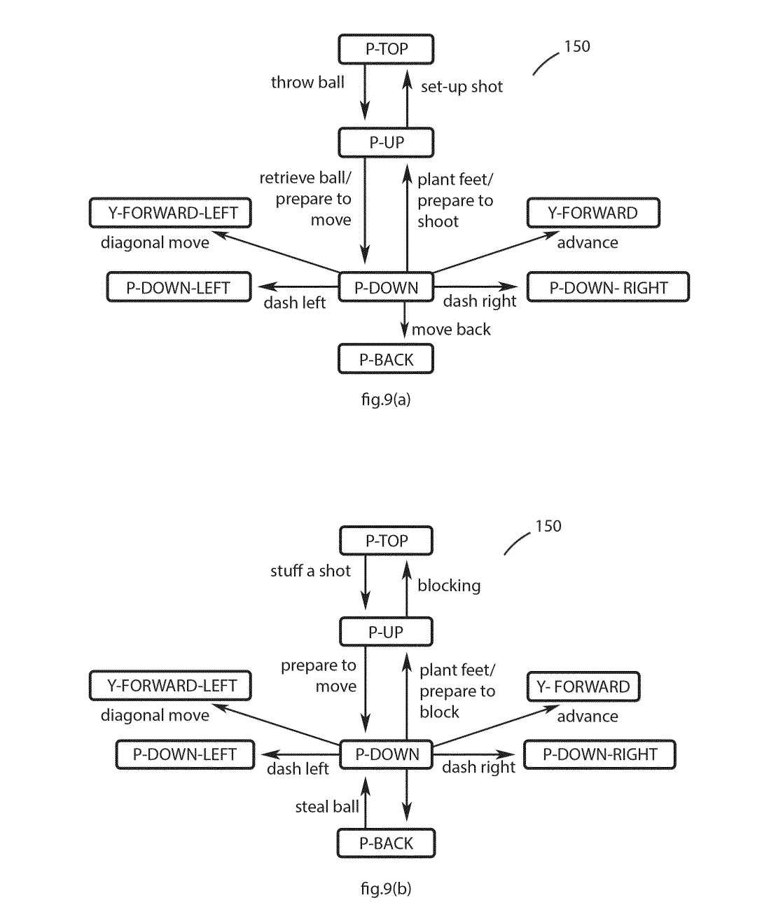

The exemplary basketball game motion, motion state diagram, and motion state library presented herein are simplified for the sake of clear exposition. FIGS. 9(a) and (b) illustrate motion state diagrams for a more complex basketball game corresponding to offense and defensive avatar control, respectively. The motion states sequences correspond, via the motion state diagram, to complex motion control hereto possible only by multi-button actuation game controllers.

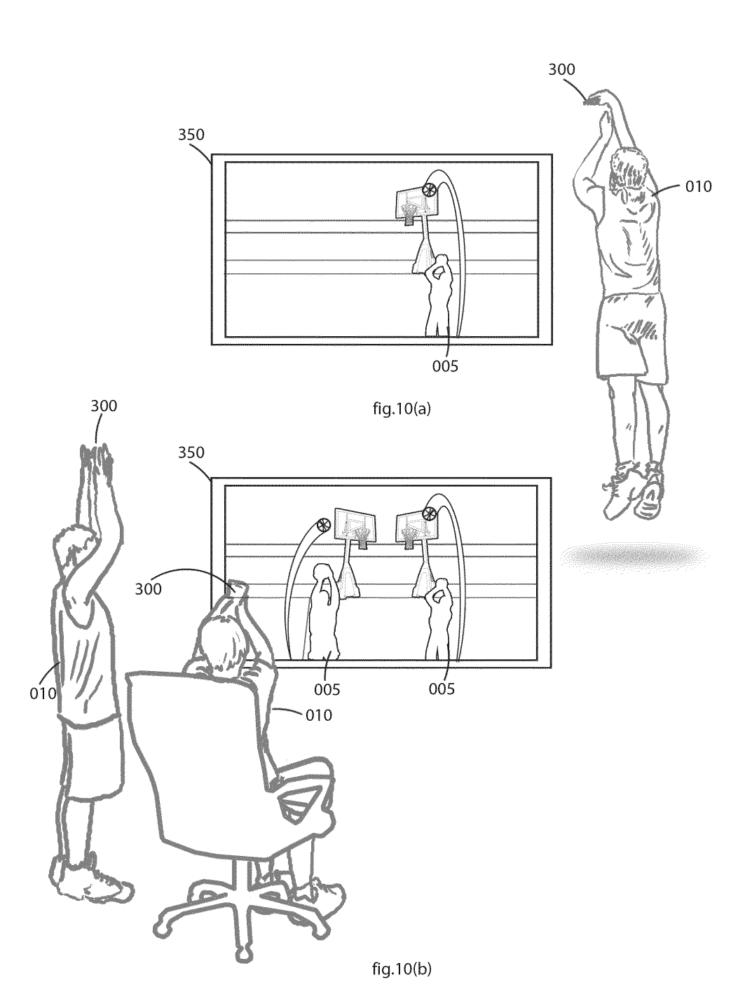

FIGS. 10(a) and (b) illustrate user 010 basketball game play in a preferred embodiment. FIG. 10 (a) illustrates a single player game where the motion states are captured by the control device 300 and controls the avatar 005 on a web-enabled display device 350. FIG. 10 (b) is a multi-player game where the users 010 can be seated or standing.

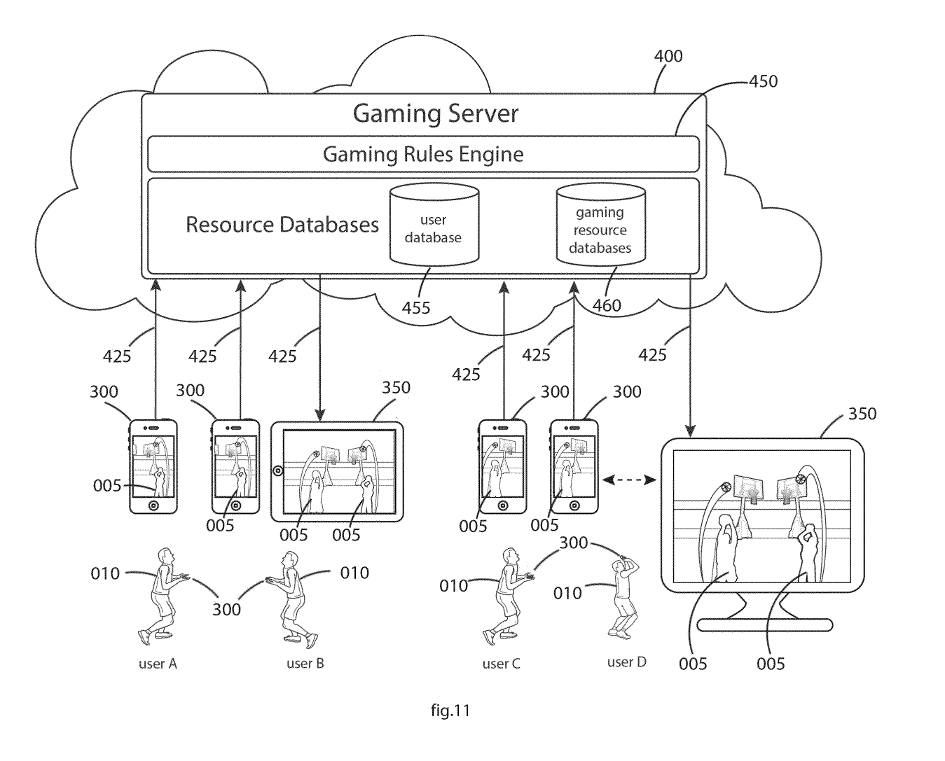

FIG. 11 illustrates an exemplary architecture of a gaming platform 500 incorporating the motion state control method 250, according to an embodiment of the present invention. The gaming platform 500 itself is disclosed in pending U.S. patent application Ser. No. 13/875,179, entitled “Web-based Game Platform with Mobile Device Motion Sensor Input” to Jeffery et al., filed on May 1, 2013, the content of which is incorporated herein by reference in its entirety.

As shown, the three major components of the gaming platform 500 are the control devices 300, a gaming server 400, and display devices 350. The gaming server 400 includes a gaming rules engine 450 that manages a plurality of games being played. As shown, the gaming rules engine 450 has access to a user database 455, and a gaming resources database 460. The user database 455 stores login information and game information. For basketball, the game information can include swing data for each shot made during the game, the player's current score, current level number, etc. The gaming resources database 460 can include graphical content for simulating the game on the display device 350.

In the illustrated embodiment, the gaming server 400 is cloud-based enabling global connectivity via the Internet 550. For each user, the user's control device 300 and display device 350 can be simultaneously connected to the gaming server 500 through separate and distinct Internet connections. The control device 300 transmits data, including analyzed motion states and state sequences and other data to the gaming server 500; in turn, the gaming server 500, facilitates display of gaming media at the display 350 through a separate Internet connection. In an embodiment, a light weight gaming graphics engine 420, in the form of a software application, can be pushed or downloaded to a suitable Web-enabled display device 350 where a substantial amount of the logic of the gaming rules engine 450 is encoded, and the gaming logic engine 420 can then perform much of the work otherwise to be performed directly at the gaming server 400.

In the following description of the present invention, exemplary methods for performing various aspects of the present invention are disclosed. It is to be understood that the methods and systems of the present invention disclosed herein can be realized by executing computer program code written in a variety of suitable programming languages, such as C, C++, C#, Objective-C, Visual Basic, and Java. It is to be understood that in some embodiments, substantial portions of the application logic may be performed on the display device using, for example, the AJAX (Asynchronous JavaScript and XML) paradigm to create an asynchronous web application. Furthermore, it is to be understood that in some embodiments the software of the application can be distributed among a plurality of different servers (not shown).

It is also to be understood that the software of the invention will preferably further include various Web-based applications written in HTML, PHP, Javascript, XML and AJAX accessible by the clients using a suitable browser (e.g., Safari, Internet Explorer, Mozilla Firefox, Google Chrome, Opera).

In a preferred embodiment 500 we implement the method 250 as a native application 306 for both Apple IOS and Android control devices 300, the gaming engine 450 using Amazon web services, and the web-enabled display 350 for all major commercially available web browsers (Chrome, IE, Firefox and Safari). Preferably, we use the Unity 3D 4.5.2 graphics engine called from the application 306 and installed in an appropriate HTML 5.0 web page of the web-enabled display 350.

Data capture on an Apple Device is enabled via the Apple iOS CMMotionManager object to capture device motion data, attitude, accelerometer and gravity. We use the Gravity method of CMAcceleration subclass of CMDeviceMotion object to capture the gravity sensor data. We use the Attitude method of CMAttitude subclass of CMDeviceMotion object to capture the attitude sensor data. We call startDeviceMotionUpdatesToQueue:withHandler method of the CMMotionManager object to begin the data capture. Data is captured at 1/100th of second's intervals. We set the data capture interval using deviceMotionUpdateInterval property.

On an Android Device we capture the sensor data using the SensorManager class. An instance of this class is created by calling Context.getSystemService( ) with SENSOR_SERVICE as a parameter. To capture the gravity data, we call getDefaultSensor method of SensorManager class with passing the parameter TYPE_GRAVITY. To capture the gyroscope data, we call getDefaultSensor method of SensorManager class with passing the parameter TYPE_GYROSCOPE. We use the registerListner method of SensorManager class to start the data capture and to set the rate of the data capture. For both Apple and Android we use these sensor data as inputs to the programmed method 250 within the native application 304.

We communicate data in the platform 500 using web socket connections. The control device 300 uses the WebSocket API to send data to the gaming server 400, and the browser 350 where the Unity 3D graphics engine is installed on the control device 300 and the web-enabled display 350. A web socket connection with the browser is persistent for the duration of a played game.

We use the WebSocket API to receive data from the control device 300 and communicate with the Unity 3D game engines. As an example, when UnityAndroid completely loads, it sends a callback to our native app “gameLoadedOnDevice()”. In the UnityWeb case, it sends a socket call back to a native browser app. The native browser app sends back the details of the play result, to UnityWeb by calling unity.sendMessage(“unity function”). To replicate the device's behavior on the web-enabled display 350, UnityAndroid or UnityiOS does all the socket communication with the server via the native app only. Appropriate methods are defined in the native app 306 that handles the socket calls. Unity just calls those methods whenever needed. The response to network calls is also listened for by the native app and it communicates these data back to Unity via unity.sendMessage(“unity function”).

The method 250 algorithm keeps running in the background when a user 010 starts the UnityAndroid or UnityiOS. Whenever the method 250 detects the state sequence 135 defined in state library 145 and subject to the state diagram 150 and state logic 175, the method 250 sends the trigger event 180 to the UnityAndroid or UnityiOS and web socket call to UnityWeb. It is to be understood that the software and systems calls disclosed in this preferred embodiment will change in the future, and therefore the embodiment is non-limiting.

For clarity in the basketball example, we illustrated the method using a single control device 300 with integrated motion sensors 304; however this example is non-limiting. The method 250 can be extended to multiple sensor 304 inputs 001, from the control device 300 and other connected devices 310. In a preferred embodiment, a motion state analyzer 100 is used for each of the control device sensor 310 inputs. The sequence analyzer 170 is then extended to receive multiple state sequences 135, wherein the state library 145 defines combinations of multiple-sensor 304 states, for defensive blocking and steeling with both arms as an example, and the state diagram 150 is similarly extended so that stage logic outputs the correct trigger event for the multiple state sequence input.

### Illustrative Game System Embodiments

In the following description we illustrate a multitude of possible variations of the present invention to video games such as football, tennis, baseball, hockey, volleyball, soccer, shooter, and fishing through their respective motion state diagrams. These examples are understood to be illustrative and non-limiting. For brevity, we disclose embodiments via the respective hand motions 075 and the motion state diagrams 150 for each example, since these diagrams, with the motion state table, enable the method 250.

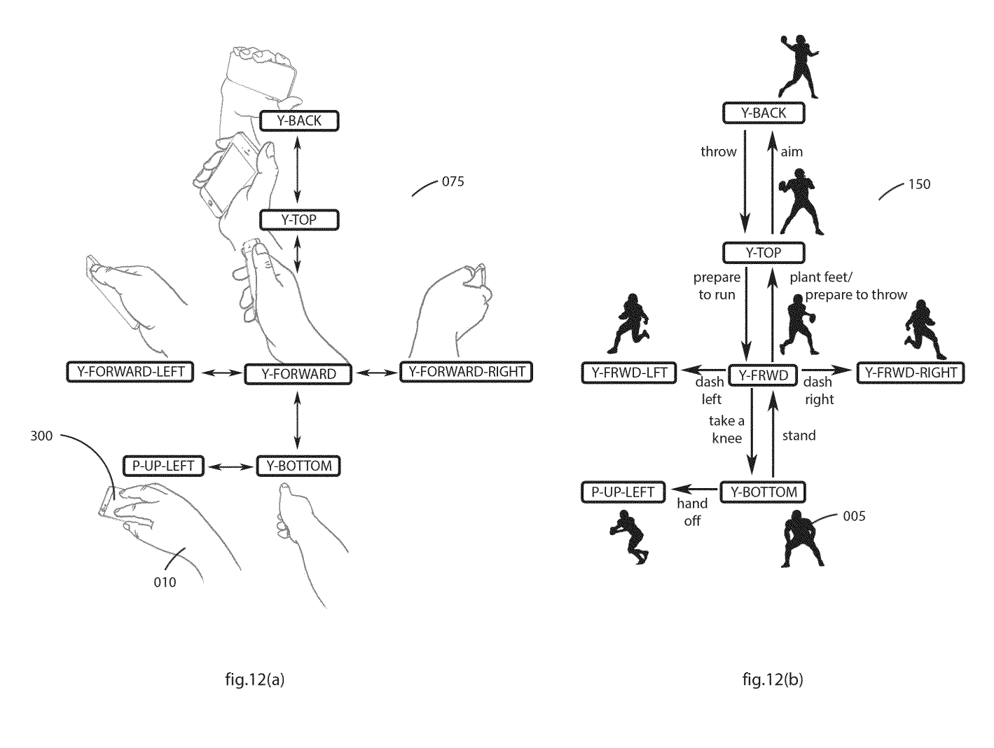

FIG. 12(a) illustrates hand motions 075 to control an avatar quarterback (QB) of a football game. The motions are primarily rotations in the yaw states, moving completely through back, top, forward and bottom with some variant states off of yaw-forward. There is one pitch state (pitch-up-left) which is reachable from yaw-bottom. FIG. 12 (b) is the corresponding motion state diagram 150 for the QB Avatar control. The full rotation through yaw correlates to the quarterback first receiving the ball from the center at Y-bottom. The QB can then either stand up (rotate to yaw-forward) or pass the ball to his/her running back (rotate to pitch-up-left). Once the quarterback has stood up and is in y-forward he/she can dash to the left or right (rotating through variants y-forward-left or y-forward-right), or prepare to throw the ball (rotate to y-top). If the QB dashes left or right, he/she will continue running left or right until the device is returned to the y-forward state. Once the QB is done running laterally he/she can rotate up to y-top where he/she is preparing a pass. Throwing a pass is a sequence of state changes that moves through y-top, y-back and returning to y-top.

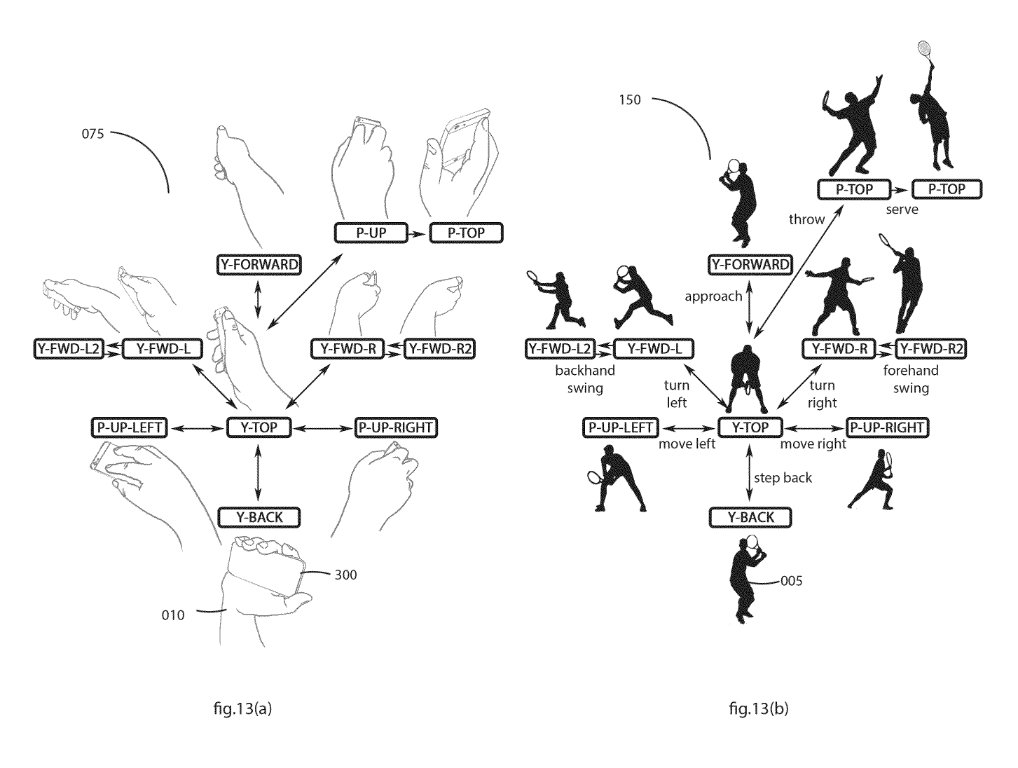

FIG. 13(a) illustrates the hand motions 075 of a tennis player and FIG. 13(b) illustrates the corresponding motion state diagram. The motions are primarily rotations in the yaw states, moving through back, top and forward and bottom with all variant states off of yaw-forward. There are four pitch states reachable from y-top. The rotation through yaw correlates to the tennis player standing ready to play and advancing up to the next as well as retreating to the back of the court. Rotations in to pitch-up state variants left and right move the player left and right on the court. Left, Left2, Right and Right2 variants off of y-forward correlate to forehand and backhand swings with a sequence of y-forward-left, y-forward-left2, y-forward-left completing a full backhand swing. The forehand swing is executed using the same sequence but on the left side. P-up and p-top states off of y-top are used when executing an overhead hit like a serve or smash. Similarly to the other swings the overhead hit is a sequence of p-up, p-top, and p-up.

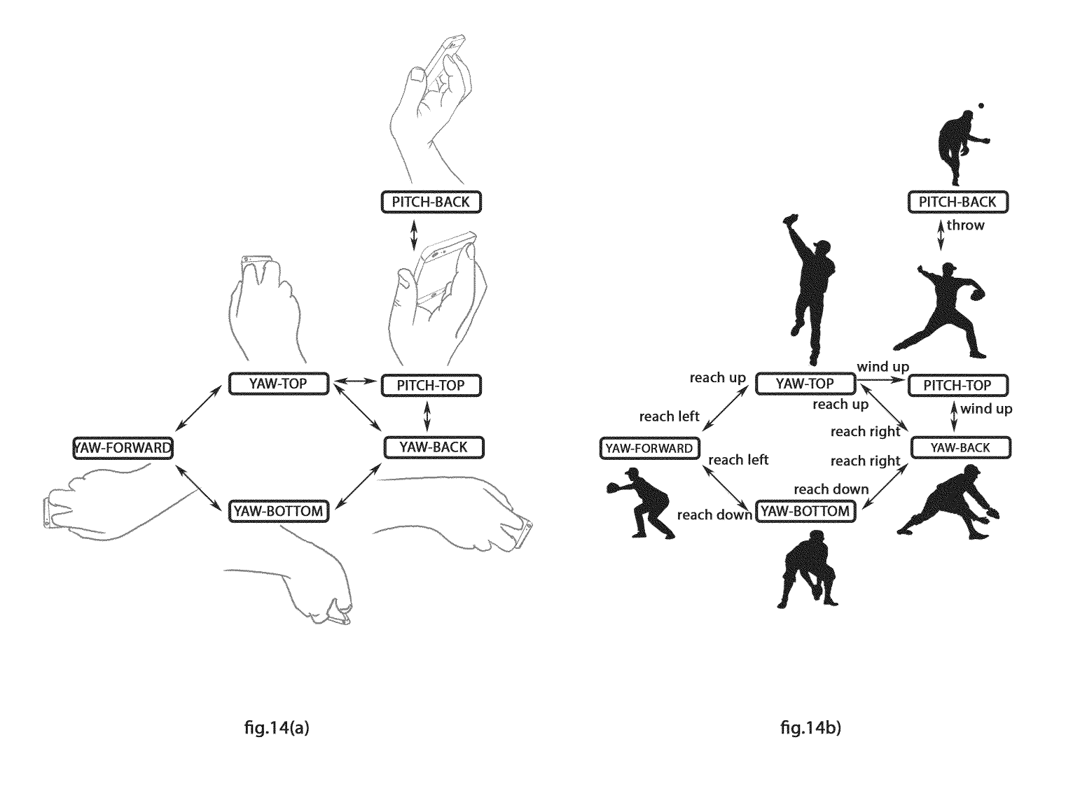

FIG. 14(a) illustrates the hand motions 075 of a baseball infielder and FIG. 14(b) illustrates the corresponding motion state diagram. The motions are primarily rotations in the yaw states, in a full circle in front of the user. Two pitch states can be reached through either yaw-top or yaw-back. The rotation through yaw correlates an infielder catching a passing ball to his/her left or right, between his/her feet, or above his/her head. The pitch states can be reached from yaw-back or yaw-top. Both yaw states connect to pitch-top which correlates to the infielder holding the ball, ready to throw. The throw sequence is pitch-top-pitch, pitch-back, and pitch-top.

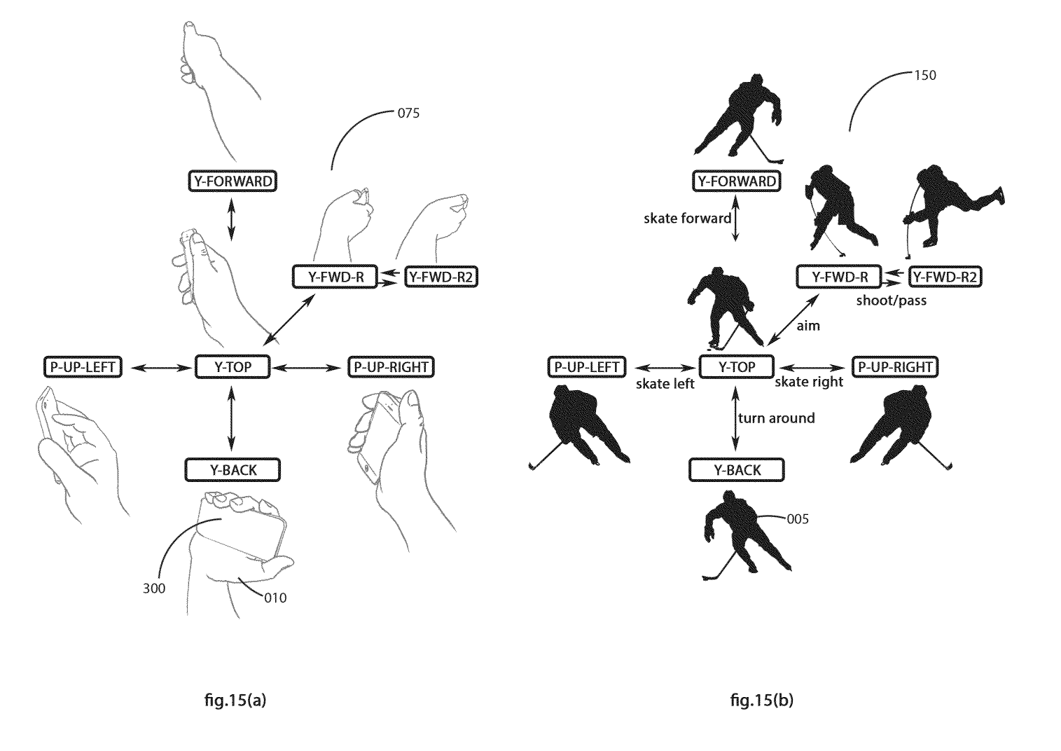

FIG. 15 (a) illustrates the hand motions 075 for hockey and FIG. 15(b) illustrates the corresponding motion state diagram. The motions are rotations in the yaw states, with two pitch states that can be reached from y-top. The rotation through yaw correlate to the hockey player advancing and retreating forward and backward. y-forward-right and y-forward-right2 state variants can be reached off of y-top for shooting and passing. The sequence for shooting and passing is y-forward-right, y-forward-right2, y-forward-right. Pitch-up variants left and right are used to control the hockey player's left and right movements. It is understood that the hockey game play the avatar undertakes involves high-speed maneuvers across a virtual ice rink.

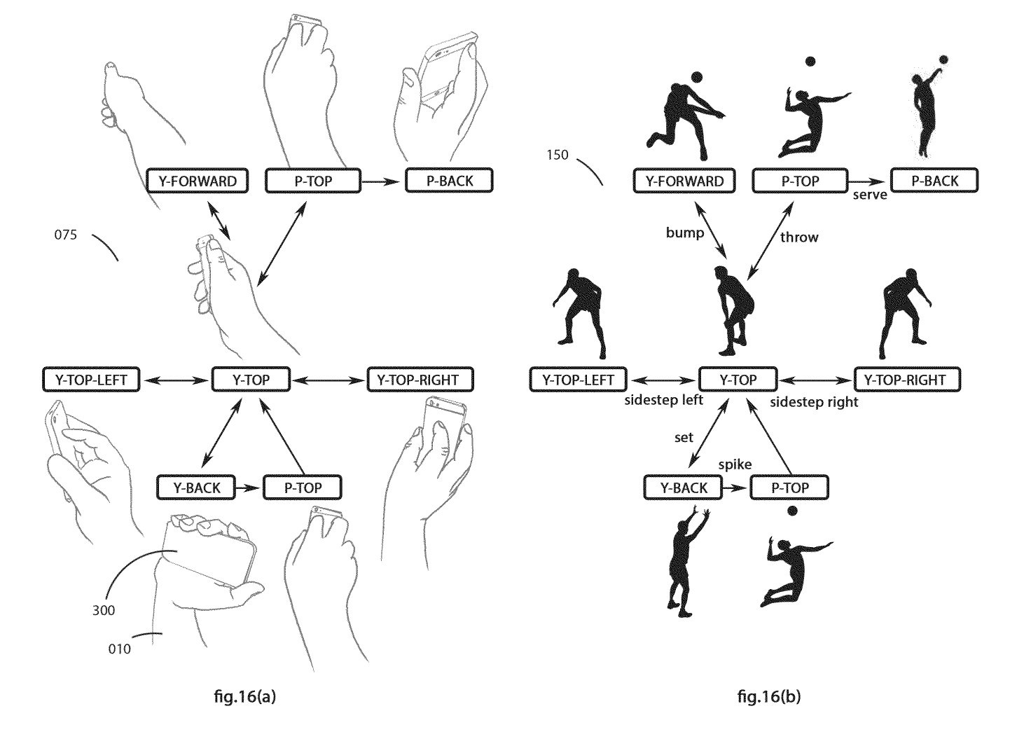

FIG. 16 (a) illustrates the hand motions 075 for volleyball and FIG. 16(b) illustrates the corresponding motion state diagram. Motions are primarily in yaw states with left right variants off of the y-top state. There are two pitch states that are also reached from y-top. Rotation through y-forward, y-top, and y-back correlate to the volleyball player's bump, ready position, and set respectively. The y-top-left and y-top-right variants correlate to the volleyball players left and right side steps. Pitch-top and pitch-back states correlate to serving the ball or spiking it. Serves are a sequence of p-top, p-back, and p-top.

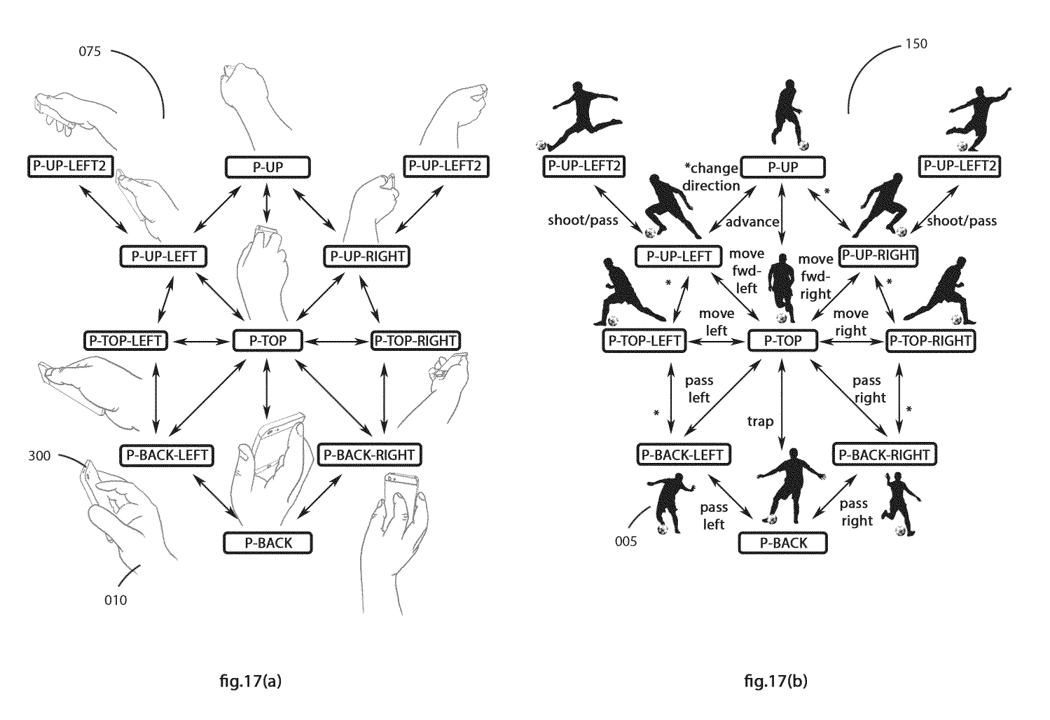

FIG. 17 (a) illustrates the hand motions 075 for soccer and FIG. 17(b) illustrates the corresponding state diagram. Motions are completely in the pitch states with many left and right variants. This diagram is centered on the p-top state. A ring of surround pitch states and their variants correlates to the soccer player running in any of eight directions. Pitch-back-left, pitch-back, and pitch-back-right control the player moving backwards and to the left, straight backwards, and backwards and to the right respectively. Pitch-top-left and pitch-top-right control the player moving directly left and right respectively. Pitch-up-left, pitch-up, and pitch-up-right control the player moving forward and left, straight forward, and forward and right respectively. Pitch-up-left2 and Pitch-up-right2 variants control shots and passes to the left and right. Shots and passes are a sequence of p-up-left, p-up-left2, p-up-left for the left side and p-up-right, p-up-right2, p-up-right for the right side.

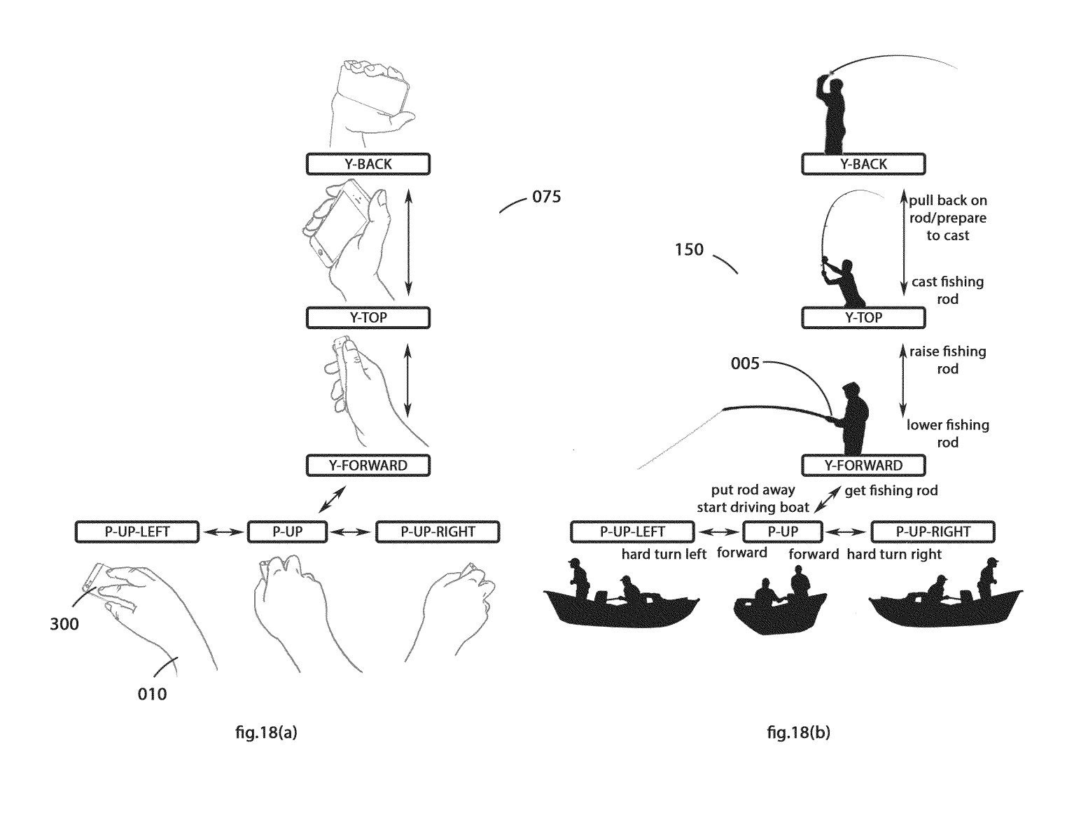

FIG. 18 (a) illustrates the hand motions 075 for fishing and FIG. 18(b) illustrates the corresponding state diagram. Motions are in yaw and pitch states with the yaw states controlling fishing activities and the pitch states controlling boat movement. The yaw-forward, yaw-top, and yaw-back states are correlated to the holding, raising, and casting of the fishing rod respectively. Casting the fishing rod is a sequence of yaw-top, yaw-back, yaw-top. Moving from yaw-forward to pitch-up stops the player from fishing and transitions them into boat driving mode. Once in pitch-up the user drives the boat forward, pitch-up-left and pitch-up-right are hard turns in either direction. Smaller turns to the left and right are controlled with motion analysis inside of the pitch-up state. Moving from yaw-forward to pitch-up transitions from fishing to boating, and similarly moving in the opposite direction stops the boat and transitions from boating back to fishing.

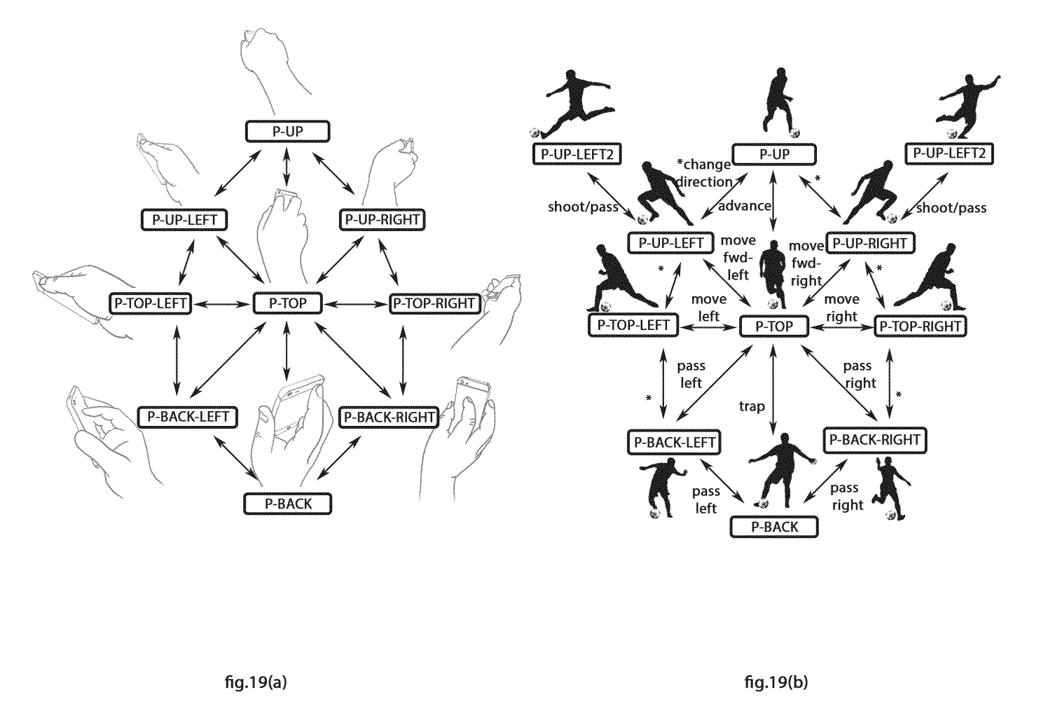

FIG. 19 (a) illustrates the hand motions 075 for a gun shooting game and FIG. 19(b) illustrates the corresponding motion state diagram. Motions are in all axes, yaw pitch and roll. Yaw-forward, yaw-top, and yaw-back states are correlated to the soldier moving forward, stopping, and reloading respectively. The soldier's movement in yaw-forward is controlled with more detailed motion analysis. Roll-left and roll-right would cause the soldier to side step in either direction. Pitch-down would cause the soldier to crouch. Pitch-top would cause the soldier to jump.

It is to be understood that many additional games may be derived from the hand motion states 075 and the motion state sequences 150 illustrated in FIGS. 5,6 and 12-19. Specifically badminton, squash, and handball are derivatives of the illustrative example for tennis, FIG. 13, and rounders and cricket are derivatives of the baseball illustration FIG. 14. Furthermore, various other throwing games maybe derived from the method disclosed herein and the method of Jeffery, et al. U.S. Published Patent Application 2013/0102419, “Method and System to Analyze Sports Motions Using Motion Sensors of a Mobile Device”. For example, bowling, beanbag toss and dart games are straight forward to derive, with motion states for picking up and holding the sports equipment (bowling ball, beanbag, horseshoe, dart) and initiating the throw, for example, wherein the actual throw is analyzed by defining a calibration point at the appropriate motion state transition for the sports motion and using the method of US. 2013/0102419 and illustrated in FIGS. 7 and 8, for basketball as an example. Furthermore, in an embodiment golf may be considered a shooting game, see FIG. 19, where the avatar must navigate a virtual golf course terrain, and the sports motion is analyzed following US. 2013/0102419.

### Non-Gaming System Control Embodiments

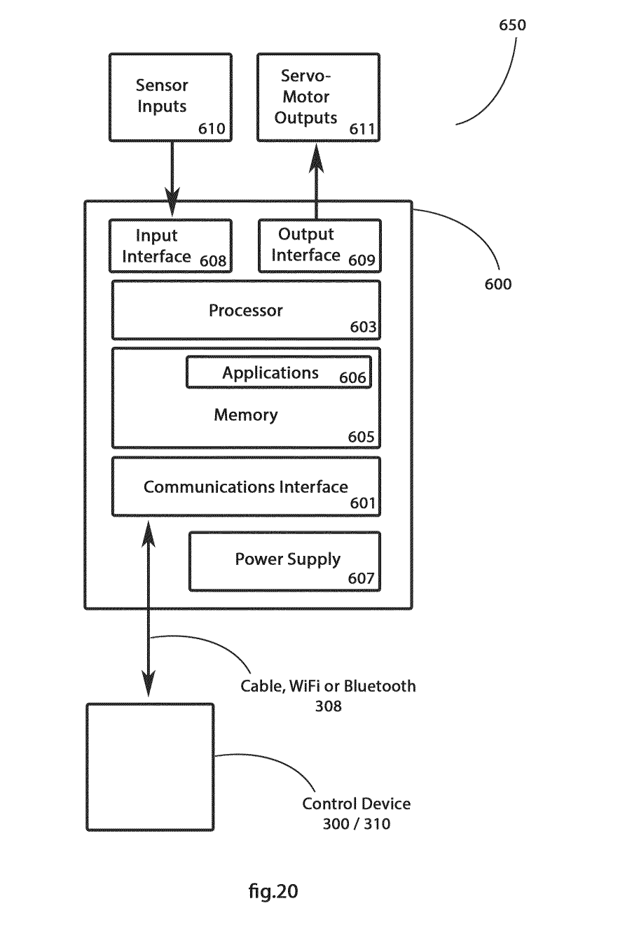

The method described herein has many applications to systems and control other than computer games. FIG. 20 is an exemplary illustration of the architecture of a robotic system 650 with a control device 300 and/or 310. The system controller 600 is the ‘brain’ of the robot or UAV and has components power supply 607, communications interface 601, processor 603, memory 605 which stores and executes the robot control software applications 606, sensor input 610 and servo motor output 611 interface circuits: these circuits respectively input various robotic sensor data to the processor 603 and the servo motor output interface enables control of the servo motors, actuators and solenoids for the respective components of the robot or UAV.

The illustrative inventive method 250 can be implemented in the control device 300, or can be distributed across both the control device 300 and the system controller 600. As an illustrative example, the state analyzer 100 may be implemented in the control device 300, and the states 135 passed to the system controller 600 wherein the sequence analyzer 170 is implemented. It is understood that there are many possible variations of the implementation possible by those skilled in the art, and hence the example is non-limiting.

An embodiment of the architecture FIG. 20 can be constructed from LEGO Mindstorms, a commercially available kit with instructions to build and program robots, appropriate for undergraduate level engineering students and advanced high schools students. See, for example, U.S. Pat. No. 6,902,461 to Munch et al., entitled “Microprocessor controlled toy building element with visual programming” the contents of which are incorporated herein in their entirety. While designed as an educational toy, the sensors and logical architecture of the LEGO robotic system are representative of many other more complex robotics embodiments, and the overall system architecture can be represented by the illustration FIG. 20.

The basic LEGO Mindstorms EV3 kit comprises a building instruction for the starter robot, TRACK3R Connecter cables, 1 USB cable LEGO Technic Elements: 594 pieces, 1 EV3 Brick (600), 2 Large Interactive Servo Motors, 1 Medium Interactive Servo Motor, 1 Touch Sensor, 1 Color Sensor, 1 Infrared Sensor, and 1 Infrared Beacon.

The EV3 processor 600 may be programmed with the LEGO MyBlocks visual object oriented programming language and users can also program in LabVIEW and Robot C. Programs may be written and compiled on an appropriate Apple or Windows PC and are transferred to the EV3 processor via a USB cable connection. The user then runs the EV3 programs via touching the screen of the EV3 Brick 600, or via the EV3 Robot Commander App on the Blue Tooth connected iPad/iPod/iPod or similar Android device.

EV3 software is an open-source platform, and Robot C is a C based programming language that can access the API library for the EV3 Brick. These API's include standard API's to connect to and communicate with iOS applications 306 via Blue Tooth. Hence, the method 250 can be implement on the controller 300, as described previously herein, and used to control the Mindstorms Robot via a Blue Tooth connection to the EV3 brick.

In an embodiment, we define motion states of the control device 300 to trigger software program execution of the EV3 brick 600. So that, as an illustrative example, the motion states p-down, p-up trigger the robot moving forward, p-down left and p-down right trigger turns left and right, respectively, and p-up, p-left trigger shooting of plastic balls. The example is illustrative however, and there is considerable flexibility of the design and software programming possible for the EV3 robot, with the ability to integrate the Servo Motors, Touch Sensor, Color Sensor, Infrared Sensor, and Infrared Beacon via the servo motor output interface 609 and the sensor interface 610, into new and unique program modules, each of which can be triggered by a motion state sequence of the control device 300.

As another illustrative example, the DENSO VP robot arm has AC servomotors 611 for each of the 6-axis of motion and is controlled by the RC8 Robot Controller 600, and is programmable by the DENSO robot language (PacScript). The ORiN2 SDK enables application development and integration of PC Visual Basic, C++, Delphi or Labview to the DENSO robot and sensors. Hence, one can integrate a control device 300 via the ORiN2 SDK for an embodiment of the architecture 650 for an industrial robot 660.

For an alternate robotic embodiment illustrative of the architecture FIG. 20, the method described herein is applied to the control of a UAV. For representative prior art see, U.S. Published Patent Application 2013/0068892 to Bin Desa et al., entitled “Flying apparatus for aerial agricultural application”; U.S. Published Patent Application 2014/0131510 to Wang et al., entitled “Unmanned aerial vehicle and operations thereof”; and U.S. Published Patent Application 2013/0173088 to Callou et al., entitled “Method for the intuitive piloting of a drone by means of a remote control”.

An exemplary illustrative embodiment of a UAV is the DJI Phantom 2 Vision+ Quadcopter with Gimbal-Stabilized 14MP, 1080p Camera manufactured by DJI and which is primarily designed for areal photography applications. The system consists of four dc motor propellers 611, a GPS receiver 610, and an A2 IMU flight controller 600, all powered by a 5200 mA/h Lithium-polymer batter 607. The A2 IMU flight controller 600 is the “brains” of the system, and consists of a processor 603, memory 605, and various sensors 610 such that stabilized flight is enabled; whereby the flight controller application software 606 varies the pitch and rotational velocity of the propellers 611, and the UAV system 650 is controlled by a ground based control device 300.

Callou et al. discloses a method for control of a UAV 655 such as the DJI Phantom 2 Vision+ whereby a control device 300, with an integrated accelerometer and gyroscope such as an iPhone/iPod Touch/iPad, is rotated in the stationary pilots hands to control the flight of the UAV 655. The bidirectional exchange of data with the UAV 655 and the control device 300 is enabled by Wi-Fi (IEEE 802.11) or a Bluetooth link 308. US 20130173088 A1 however makes use of continuous motions of pitch and roll of the control device, rather than motion states.

FIG. 20 (a) is an exemplary illustration of the motion states 075 to control a UAV 655 and (b) the corresponding motion state diagram 150. In an embodiment the method 250 is implemented as a software application 306 in the control device 300, and trigger events 180 are transmitted to the UAV 655 via Wi-Fi or Bluetooth link. The UAV 655 processes the trigger events 180 in the flight controller processor 600, whereby the output actions 201 are executed via 611 as servo motor and actuator sequences, which may incorporate the onboard GPS, altitude, radar and other sensor inputs 610 as appropriate.

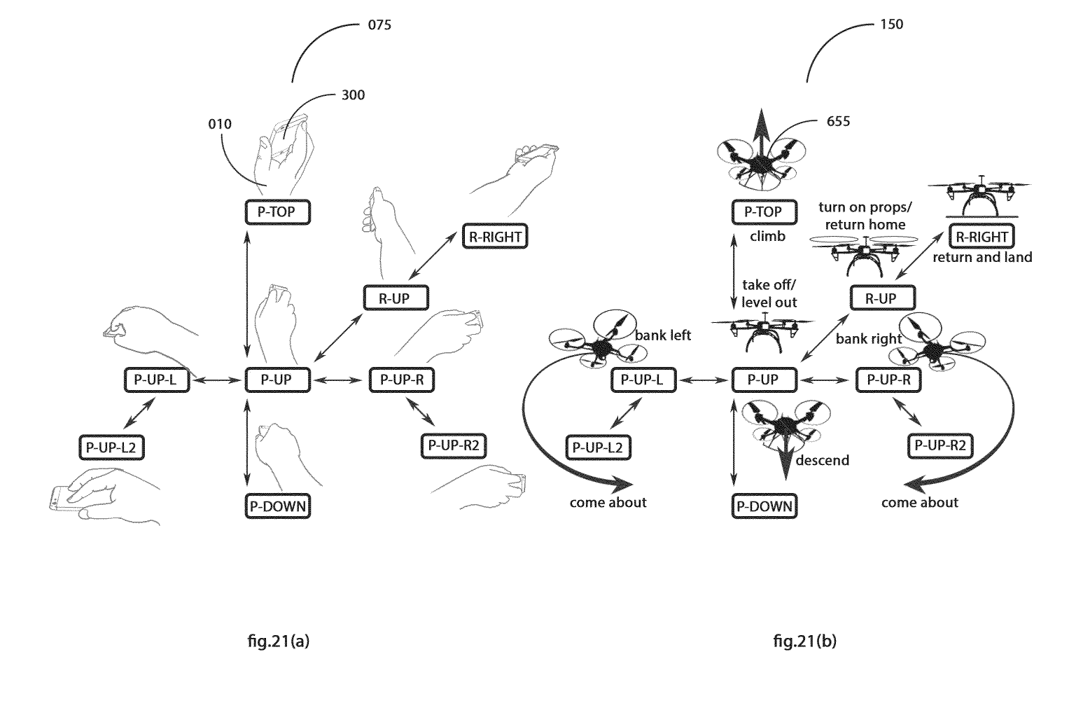

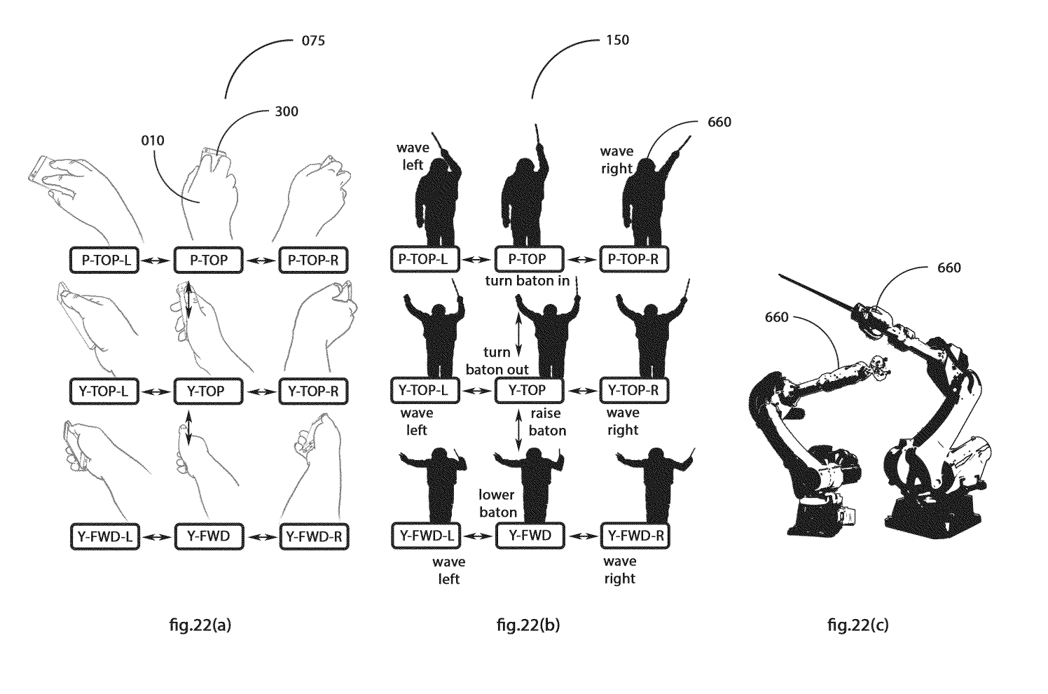

As an illustrative example using motion states to control the flight of a UAV 655, in FIG. 21 (b) the user starts with the control device screen facing up; in this pre-flight state the UAV is understood to be on the earth with propellers off. The user then turns the phone from roll-right to roll-up (like turning the keys in a car ignition to ON). This turns the propellers on and ready's the UAV for take-off via the flight controller. Then the user completes the turn to the pitch-up position (turning the phone completely over). The UAV takes off and rises to a default height off of the ground. From here the user can have the UAV climb to check-point altitudes by performing pitch-up pitch-top state changes. The user could also have the UAV turn left or right by performing pitch-up pitch-up-left OR pitch-up-right state changes. Full turns to pitch-up-left2 OR pitch-up-right2 would bring the UAV around completely. Rotating the control device 300 back to the starting position (screen facing up) would trigger the UAV to return to its homebase and power down.

FIG. 21 is an illustrative example with a simplified motion state diagram for clarity of exposition. It is to be understood that many more sequences of motion states may be defined, each mapped into complex UAV 600 control sequences by the flight controller 300. Furthermore, one can combine discreet motion states FIG. 21 (a) with continuous motion gyroscope data of the control device 300, so that if the control device 300 is in the yaw-forward state, screen facing the user 010, then plus or minus 35 degree continuous yaw rotations of the control device 300 control the UAV to execute the same degree of continuous yaw, as an illustrative example. Furthermore, it is understood that the method is not limited to the DJI Phantom 2 Vision+ Quadcopter illustrative examples, but is generalizable to all other types of aircraft.

As a final example, in FIGS. 21(a)-(b) we show how the invention can be applied to conducting an orchestra. In this exemplary embodiment an industrial robot 660, or preferably a human like “animatronic” robot such as the HONDA ASIMO, is controlled via the method 250 and control device 300 in order to “conduct” an orchestra. Prior art of the HONDA ASIMO and Geuther et al, “A Study on Musical Conducting Robots and Their Users,” 2010 IEEE-RAS International Conference on Humanoid Robots Nashville, Tenn., USA, Dec. 6-8, 2010, effectively prerecorded robot arm motions for playback in front of an orchestra. The system 650 is applicable to the HONDA ASIMO and the LEGO Mindstorm robot created by Geuther et al. to conduct an orchestra. One can also substitute industrial robot arms 660 by DENSO, KUKA, or ST ROBOTICS described previously.

FIG. 20 (a) illustrates the hand motions 075 for conducting an orchestra and FIG. 20(b) illustrates the corresponding state motion diagram. Motions are in three states pitch-top, yaw-top and yaw-forward. Each state then has two additional variants to the left and right. An animatronic robot 006 can hold the baton up palm forward (pitch top) and wave the baton left and right (pitch-top-left and pitch-top-right). The animatronic robot 006 can also hold the baton top palm in (yaw-top) and wave the baton left and right (yaw-top-left and yaw-top-right). It can also hold the baton forward palm in (yaw-forward) and swing the baton left and right (yaw-forward-left and yaw-forward-right). Additional motion state sequences can be defined to enable the animatronic robot 006 to automatically make the continuous motions for 3/4 or 4/4 time, as examples.

The inventive method 250 with multiple sensors could be further used for the control of the orchestra, wherein the primary control device 300 is held in the right hand by the user 010 and a secondary wirelessly connected control device 310 is attached to the left wrist of the user 010. States can be defined for the 310 sensors, such that changing the motion state of 310 from p-down to p-up could trigger the raising of the left arm of the robot 660, which in-conjunction to the motion state sequences from the device 300 controlling the right arm of the robot 660, would signal the orchestra to play with increased intensity, for example.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention made without departing from the spirit and scope of the invention.

What is claimed is:

1. A method for controlling a system, comprising:
obtaining motion sensor data of a system controller;
determining a current motion state of the system controller using the obtained motion sensor data; and
controlling the system based at least in part on a sequence from a previous motion state to the current motion state of the system controller;
wherein motion state refers to one of a plurality of predetermined ranges of orientation around an axis in three-dimensional space.

2. The method of claim 1, wherein the step of controlling the system is performed only if the current motion state is a valid motion state for the system.

3. The method of claim 2, wherein the step of controlling the system is performed only if the sequence from a previous motion state to the current motion state of the system controller is a valid sequence.

4. The method of claim 1, wherein the current motion state and the previous motion state include ranges of motion about the same axis in three-dimensional space and together with at least two other motion states cover a range of motion entirely around the axis.

5. The method of claim 1, wherein the obtained motion data includes data obtained from a gyroscope and an accelerometer.

6. The method of claim 1, wherein the step of determining the motion state includes:
determining gravity data and attitude data using the obtained motion sensor data; and
determining the motion state using the determined gravity data and attitude data;
wherein each motion state is defined according to a predetermined range of gravity data and attitude data.

7. The method of claim 6, wherein determining the gravity data includes applying a low pass filter to accelerometer data from the obtained motion sensor data.

8. The method of claim 6, wherein the gravity data is obtained in part from the combination of accelerometer and gyroscope data.

9. The method of claim 6, wherein determining the attitude data includes integration of rotational velocity obtained from the motion sensor data.

10. The method of claim 6, wherein the motion states that are rotations about axes that are tangential to the earth gravity vector are derived from n-degree rotations of a gravity sensor, each starting p-degrees from axes of a coordinate system.

11. The method of claim 6, wherein the motion states that are in a plane tangential to the surface of the earth are derived from m-degree rotations of attitude, each starting q-degrees from an initial starting point.

12. The method of claim 11 wherein the starting point of rotations of attitude are at least in part based upon last gravity state orientation.

13. The method of claim 11 wherein the obtained motion data includes compass data, and the starting point of rotations of attitude is at least in part based upon the compass data.

14. The method of claim 13, further including the step of applying a low pass filter to the compass data.

15. The method of claim 13, wherein compass data is obtained in part using gyroscope data.

16. The method of claim 9, wherein the coordinate system is a Cartesian coordinate system.

17. The method of claim 10, wherein the coordinate system is a Cartesian coordinate system.

18. The method of claim 9, wherein n=90 degrees and p=45 degrees.

19. The method of claim 10, wherein m=90 degrees and q=45 degrees.

20. The method of claim 1, wherein the system controller is a hand-held control device.

21. The method of claim 1, wherein controlling the system is further based on one or more of angular and acceleration data derived from the obtained motion sensor data, interpreted in light of the current motion state.

22. The method of claim 1, wherein the system controller further includes an external device communicatively coupled thereto including additional sensors.

23. The method of claim 1, wherein the system is a game.

24. The method of claim 23, where the game relates to: basketball, American football, tennis, badminton, squash, handball, baseball, rounders, cricket, beanbag toss, bowling, horseshoes, darts, hockey, volleyball, soccer, fishing, shooting or golf.

25. The method of claim 1, wherein controlling the system includes controlling a robot.

26. The method of claim 1, wherein controlling the system includes controlling flight.

27. The method of claim 2, wherein the current motion state is a valid motion state if the motion state is listed in a motion state table for the system.

28. The method of claim 3, wherein the motion state sequence is a valid motion state sequence if the motion state sequence is listed in a motion state sequence for the system.

29. A method for controlling a system, comprising:
obtaining motion sensor data of a system controller;
determining a current motion state of the system controller using the obtained motion sensor data;
determining if the current motion state and the motion state sequence from the previous motion state are valid for the system; and
controlling a physical movement, based at least in part on a sequence from a previous motion state to the current motion state of the system controller, if the current motion state and the previous motion state are different motion states.

30. A method for building a control system, comprising:
for each axis of a three-dimensional coordinate system, assigning a range of motion along the respective axis as one of a plurality of motion states;
defining a set of valid motion states for the system from the plurality of assigned motion states;
defining a set of motion state sequences, each motion state sequence including a sequence from one of the defined motion state to another such defined motion state; and
defining a set of system inputs for each of the motion state sequences.
